(19) United States
(12) Patent Application Publication
(10) Pub. No.: US 2018/0049433 A1
(43) Pub. Date: Feb. 22, 2018

(54) SEMIOCHEMICAL COMPOSITIONS FOR THE PREVENTION OF HEMATOPHAGOUS DIPTERA INSECTS FROM LANDING AND BITING ANIMALS

(71) Applicant: INSTITUTE DE RECHERCHE EN SEMIOCHIMIE ET ETHOLOGIE APPLIQUEE, APT (FR)

(72) Inventor: Patrick Pageat, APT (FR)

(73) Assignee: INSTITUT DE RECHERCHE EN SEMIOCHIMIE ET ETHOLOGIE APPLIQUEE, APT (FR)

(21) Appl. No.: 15/555,572

(22) PCT Filed: Mar. 3, 2016
(86) PCT No.: PCT/IB2016/000336

§ 371 Date: Sep. 5, 2017

Related U.S. Application Data
(60) Provisional application No. 62/129,147, filed on Mar. 6, 2015.

(51) Int. Cl. A01N 37/02

(52) U.S. Cl. CPC A01N 37/02

(57) ABSTRACT

A semiochemical composition comprising a Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid including their salts thereof, their derivatives thereof, their isomers thereof and/or their structural analogs thereof that retain their semiochemical activity and/or their mixtures thereof and an acceptable vehicle. Methods to prevent Hematophagous Diptera insects from landing and biting animals are also disclosed.

### FIELD OF THE INVENTION

The present invention relates to a semiochemical composition comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid including their salts thereof, their derivatives thereof, their isomers thereof and/or their structural analogs thereof that retain their semiochemical activity and/or mixtures thereof and an acceptable vehicle.

In another aspect the present invention relates to a semiochemical composition comprising a synthetic Hematophagous Diptera bite inhibitor semiochemical composition comprising at least one of the following mixtures of cyclic compounds and methylated cyclic compounds: 3-cyclopentyl propionic acid and 3-cyclohexyl 2-methyl propionic acid, or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, including their salts thereof, their derivatives thereof, their isomers thereof and/or their structural analogs thereof that retain their semiochemical activity and/or their mixtures thereof and an acceptable vehicle. Methods to prevent Hematophagous Diptera insects from landing and biting animals comprising administering to animals in need of such treatment an insect bite inhibiting semiochemical composition, as described herein, is also part of the present invention, as well as use of the semiochemical composition as an insect landing and biting animals preventative.

### BACKGROUND OF THE PRESENT INVENTION

Insects are a class of living creatures within the arthropods that have a three part body head, thorax and abdomen), three pairs of jointed legs, compound eyes, a pair of antennae and a chitonous exoskeleton. Arthropods form the phylum Arthropoda, and include the insects, arachnids, and crustaceans.

Among the insects, blood feeding insects can be very dangerous since they act as vectors that spread various diseases such as malaria, encephalitis, West Nile disease, dengue fever, St. Louis encephalitis, filariasis, leishmaniasis, heartworm and yellow fever. The blood feeding insects or haematophagus insects are those from the Order Diptera, the Order Siphonaptera, the Order Hemiptera and the Order Phthiraptera.

Included in the Order Diptera are mosquitoes, Family Culcidae, biting midgets, Family Ceratopogonidae, tsetse flies, Family Glossinidae, sheep keds, Family Hippoboscidae, stable and horn flies, Family Muscidae, sand flies, Family Psychodidae, snipe flies, Family Rhagionidae, black flies, Family Simuliidae and horse fly Family Tabanidae.

The Order Siphinaptera includes fleas such as sticktight and chigoes fleas Family Hectopsyllidae, cat fleas (Ctenocephalides felis), Northern rat fleas (Nosopsyllus fasciatus), human fleas (Pulex irritans) and oriental rat fleas (Xenopsylla cheopis).

The Order Phthiraptera includes lice such as Head louse (Pediculus humanus capitis), Body louse (Pediculus humanus humanus) and Pubic louse (Phthirus pubis), which are under the Suborder of Anoplura.

Insect-transmitted disease remains a major source of illness and death worldwide. In fact the animal that is responsible for the most human deaths in the world is the mosquito. Only a single bite from an infected arthropod can result in the transmission of disease.

There are approximately 3,500 species of mosquitoes in forty-one genera. Mosquitoes belong to the family Culicidae and are almost all blood suckers. The three most significant genera are the Aedes, Anopheles and Culex. A mosquito can weigh between 2 and 2.5 milligrams and female mosquitoes can drink around 5-millionths of a liter of blood. Only females suck blood since their mouthparts are needle like and suited to that purpose. The males feed on nectar.

A mosquito can detect a moving target from eighteen feet away and usually bite at dawn or at dusk. Mosquitoes select their victims by evaluating scent, exhaled carbon dioxide and the chemical's in a person's sweat. Mosquitoes are more likely to bite men, people with type O blood and overweight people,

Gnats are from the Diptera family having two wings and are a type of fly. Several small flying insects qualify as gnats. They are barely noticeable until they begin to swarm. Gnats multiply quickly laying hundreds of eggs in a short amount of time. Some gnats bite, cause irritation and spread disease.

Examples of gnats that bite are black flies and sand gnats. Blackflies, like mosquitoes, are blood sucking and only the females bite. The males mostly eat nectar. They are very small and can be black or grey in color. Blackflies are from the Family Simuliidae. The Simuliidae (blackflies) is a family of Diptera containing about 2,132 species (2,120 living and 12 fossil) (Adler & Crosskey, 2012).

Blackflies can also spread disease such as river blindness, which is a parasitic infection that occurs through the bite of a black fly having a worm parasite. The worm parasite enters the body and produces thousands of larval worms, which are toxic to the skin and eye. This toxicity in turn causes extreme itching and eye lesions that may lead to low vision or irreversible blindness, as well as disfiguring skin diseases. Nearly 37 million people have been affected with this disease and nearly 300,000 have been blinded or visually impaired.

Sand gnats have perfect mouths for living on blood. Unlike mosquitoes, sand gnats puncture the skin by using their sharp teeth located on the mandible. They then insert two dagger-like blades that rip up the skin so that blood begins to flow. Once blood begins to flow sand gnats squirt a chemical into the wound to stop the blood from clotting. Once a pool of blood has formed they use a proboscis to drink the blood. Sand gnat bites tend to leave the skin itchy, red and swollen. They cause a lot of pain and discomfort and their wounds can turn infectious.

Biting midgets feed on both humans and other mammals. Culicoides is a genus of biting midgets in the family Ceratopogonidae. There are about 500 species of Ceratopogonidae and this is split into many subgenera. Adults are small dark insects about 1 to 3 mm long. The antennae are long having about 15 segments and are densely haired in males and less hairy in females. The thorax is hooped and supports a pair of broad mottled wings. Both the males and females feed on nectar, but only the females feed on blood. Different Culicoides species have been shown to be vectors for various viruses and conditions. These are Mansonella ozzardi, Mansonella perstans, Mansonella streptocerca, Onchocerca gibsoni, Onchocerca cervicalis, Leucocytozoon, Plasmodium agamae, bluetongue virus, African horse sickness, bovine ephermeral fever, Akabane virus, Queensland itch and Epizootic Hemorrhagic Disease.

Currently insect repellents are on the market such as N,N-diethyl-meta-toluamide (DEET), picaridin KBR 3023), oil of lemon eucalyptus and citronella oil. However, a product containing 4.75% of DEET provides only one and a half hour of protection, while a product containing 23.8% of DEET provides five hours of protection. By encapsulating DEET the protection from insects can be obtained to up to 10 hours. A 20% concentration of DEET or picaridin typically provide longer lasting protection than oil of eucalyptus or citronella oil. In fact to be effective citronella oil must be reapplied to the skin every 30 to 60 minutes.

Factors that play a role in any repellant's effectiveness include its concentration, the frequency and uniformity of its application, evaporation and absorption from the skin surface, rain or sweat that may wash off the repellant, high temperatures or a windy environment.

DEET however does have its drawbacks in that it can irritate the skin, interacts with certain plastics, can corrode clothing and camping materials, has a particular odor, is sticky when applied to skin and is restricted to a certain age for application. Furthermore, DEET has little “spatial activity” meaning that nearby untreated skin is likely to be bitten.

Although picaridin is less toxic, less sticky and less toxic than DEET it is also less effective than DEET to repel insects.

Thus, there is a need in the insect repellant art to provide an alternative to those insect repellents that are currently on the market that is safe, less toxic and effective in repelling insects.

Semiochemicals are chemicals emitted by a plant or an animal that evoke a behavioral or physiological response in another organism. When the semiochemical affects an individual of the same species, it is called a pheromone. When the semiochemical affects an individual of a different species, it is called an allelochemical.

Those chemical signals that participate in interspecific communications are grouped under the general category of allelochemical signals. The allelochemical signals are generally divided into two subgroups and their function affects the relationship between the emitter of the signal and the receiver of the message. When there is a chemical signal that is emitted, that in relation to the favorable emitter, the sub grouping is known as an allomone. By definition, an allomone is a semiochemical substance produced by one species that has an effect upon another species, especially so as to benefit the emitting species. For example, attractive allomones emitted by certain flowers can attract various insects that can pollinate these flowers.

In contrast, when the chemical signal emitted is in relation favorable to the receiver the sub grouping is known as a kairomone. A kairomone, by definition, is a semiochemical substance that can attract other species and sometimes even natural enemies. The kairomones are sometimes implicated in locating a particular host by a parasite. For example, lactic acid that is emitted by human skin is a kairomone known for a number of Culicidae. Allomones and kairomones are natural substances that degrade causing no harm to the end user. These chemicals also do not cause immunity and are safe.

Hence there is a need in the art to provide a semiochemical composition to repel Hematophagous Diptera insects and a method to prevent Hemtophagus Diptera from landing and biting animals.

This need and other objects are achieved by the present invention as evidenced by the summary of the invention, description of the preferred embodiments and the claims.

### SUMMARY OF THE INVENTION

The present in invention provides a semiochemical composition comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle.

In another aspect the present invention provides a semiochemical composition comprising a synthetic Hematophagous Diptera bite inhibitor semiochemical, said composition comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclohexyl propionic acid and methylated cyclohexyl acetic acid or 3-cyclopentyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that retain their semiochemical activity and/or their mixtures thereof and an acceptable vehicle.

The acceptable vehicle, as described herein, is a pharmaceutically acceptable vehicle or a veterinarian acceptable vehicle.

In another aspect the semiochemical composition comprising a synthetic Hematophagous Diptera bite inhibitor semiochemical composition comprises at least one compound selected the group of from between about 0.01% (w %/w %) to about 10% (w %/w %) 3-cyclopentyl 2-methyl propionic acid, from between about 0.01% (w %/w %)) to about 10% (w %/w %) 3-cyclohexyl 2-methyl propionic acid and from between about 0.01% (w %/w %) to about 10% (w %/w %) methylated cyclohexyl acetic acid. Their salts thereof, their derivatives thereof, their isomers thereof and/or their structural analogs thereof that retain their semiochemical activity and/or their mixtures thereof of 3-cyclopentyl 2-methyl propionic acid, 3-cyclohexyl 2-methyl propionic acid or methylated cyclohexyl acetic acid are present in the same amount.

The semiochemical composition comprising a synthetic Hematophagous Diptera bite inhibitor semiochemical composition comprises at least one compound selected from the group of between about 0.05% (w %/w %) to about 15% (w %/w %) 3-cyclopentyl 2-methyl propionic acid, from between about 0.05% (w %/w %) to about 15% (w %/w %) 3-cyclohexyl 2-methyl propionic acid and from between about 0.05% (w %/w %) to about 15% (w %/w %) methylated cyclohexyl acetic acid is yet another embodiment of the present invention. Their salts thereof, their derivatives thereof, their isomers thereof and/or their structural analogs thereof that retain their semiochemical activity and/or their mixtures thereof of 3-cyclopentyl 2-methyl propionic acid, 3-cyclohexyl 2-methyl propionic acid or methylated cyclohexyl acetic acid are present in the same amount.

In another aspect the semiochemical composition comprising a synthetic Hematophagous Diptera bite inhibitor semiochemical comprises at least one of the following mixtures of cyclic compounds and methylated cyclic compounds, wherein the 3-cyclopentyl propionic acid and 3-cyclohexyl 2-methyl propionic acid is present in the semiochemical composition in a range of between about 0.01% (w %/w %) to about 10% (w %/w %); 3-cyclopentyl 2-methyl propionic acid and 3-cyclohexyl propionic acid is present in the semiochemical composition in a range of between about 0.01% (w %/w %) to about 10% (w %/w %); the 3-cyclopentyl propionic acid and methylated cyclohexyl acetic acid is present in the semiochemical composition in a range of between about 0.01% (w %/w %) to about 10% (w %/w %); the 3-cyclohexyl propionic acid and methylated cyclohexyl acetic acid is present in the semiochemical composition in a range of between about 0.01% (w %/w %) to about 10% (w %/w %); the 3-cyclohexyl propionic acid and 3-cyclohexyl 2-methyl propionic acid is present in the semiochemical compositions in a range between about 0.01% to about 10% (w %/w %); the 3-cyclopentyl propionic acid and 3-cyclopentyl 2-methyl propionic acid is present in the semiochemical composition a range of between about 0.01% (w %/w %) to about 10% (w %/w %); the cyclohexyl acetic acid and methylated cyclohexyl acetic acid is present in the semiochemical composition in a range of between about 0.01% (w %/w %) to about 10% (w %/w %); the 3-cyclopentyl 2-methyl propionic acid and cyclohexyl acetic acid is present in the semiochemical composition in a range of between about 0.01% (w %/w %) to about 10% (w %/w %); and the 3-cyclohexyl 2-methyl propionic acid and cyclohexyl acetic acid is present in a range of between about 0.01% (w %/w %) to about 10% (w %/w %). The salts thereof, derivatives thereof, isomers thereof and/or structural analogs thereof that retain their semiochemical activity and/or mixtures thereof are present in the same amount.

A semiochemical composition comprising a synthetic Hematophagous Diptera bite inhibitor semiochemical comprises at least one of the following mixtures of cyclic compounds and methylated cyclic compounds, wherein the 3-cyclopentyl propionic acid and 3-cyclohexyl 2-methyl propionic acid is present in the semiochemical composition in a range of between about 0.05% (w %/w %) to about 15% (w %/w %); 3-cyclopentyl 2-methyl propionic acid and 3-cyclohexyl propionic acid is present in the semiochemical composition in a range of between about 0.05% (w %/w %) to about 15% (w %/w %); the 3-cyclopentyl propionic acid and methylated cyclohexyl acetic acid is present in the semiochemical composition in a range of between about 0.05% (w %/w %) to about 15% (w %/w %); the 3-cyclohexyl propionic acid and methylated cyclohexyl acetic acid is present in the semiochemical composition in a range of between about 0.05% (w %/w %) to about 15% (w %/w %); the 3-cyclohexyl propionic acid and 3-cyclohexyl 2-methyl propionic acid is present in the semiochemical compositions in a range between about 0.05% to about 15% (w %/w %); the 3-cyclopentyl propionic acid and 3-cyclopentyl 2-methyl propionic acid is present in the semiochemical composition a range of between about 0.05% (w %/w %) to about 15% (w %/w %); the cyclohexyl acetic acid and methylated cyclohexyl acetic acid is present in the semiochemical composition in a range of between about 0.05% (w %/w %) to about 15% (w %/w %); the 3-cyclopentyl 2-methyl propionic acid and cyclohexyl acetic acid is present in the semiochemical composition in a range of between about 0.05% (w %/w %) to about 15% (w %/w %); and the 3-cyclohexyl 2-methyl propionic acid and cyclohexyl acetic acid is present in a range of between about 0.05% (w %/w %) to about 15% (w %/w %). Their salts thereof, their derivatives thereof, their isomers thereof and/or their structural analogs thereof that retain their semiochemical activity and/or their mixtures are present in the same amount.

In another aspect the semiochemical composition comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle can further comprise a nontoxic filler or an enhancer composition. The nontoxic filler is selected from the group of fatty acids, alcohols, amines, squalene, glycerol and mixtures thereof, while the enhancer composition contains amines and fatty acids from indolic derivatives, esters of these amines and fatty acids, ketones, acetone, alcohols or sterols.

The semiochemical composition comprising a synthetic Hematophagous Diptera bite inhibitor semiochemical, said composition comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that retain their semiochemical activity and/or their mixtures thereof and an acceptable vehicle can further comprise a nontoxic filler or an enhancer composition. The nontoxic filler is selected from the group of fatty acids, alcohols, amines, squalene, glycerol and mixtures thereof, while the enhancer composition contains amines and fatty acids from indolic derivatives, esters of these amines and fatty acids, ketones, acetone, alcohols or sterols.

The semiochemical composition, as described herein, can be in the form of powders, tablets, pellets, capsules, granulated, granulated particles, dry flakes or other forms suitable for use.

The semiochemical composition, as described herein, can be diluted in a suitable solvent. It can then be administered to areas of the skin of the animal or in the environment of the animal.

In yet another aspect a semiochemical solution is provided containing the composition comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle.

A semiochemical solution containing the composition comprising a synthetic Hematophagous Diptera bite inhibitor semiochemical, said composition comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their isomers thereof and/or their structural analogs thereof that maintain their semiochemical capabilities and/or their mixtures is another aspect of the invention.

The semiochemical solutions can also contain a nontoxic filler, as described herein, or an enhancer composition, as described herein.

These semiochemical solutions can be formulated with an acceptable vehicle such as a veterinarian acceptable vehicle or a pharmaceutically acceptable vehicle.

The semiochemical solution in the acceptable vehicle can be in the form of a diffuser, a spray, an aerosol, an emulsion, a suspension, in the form of drops, a towelette, a cream, a shampoo, soap, a lotion, a gel, a microencapsulated spray, a granulated resin, an extruded polymer, an injected polymer or molded polymer in the form of a collar, a candle or in a slow release matrix, in insect repellant wrist bands, in tablecloths, tissue, microporous cartridges having membranes for passive diffusion and clothes. It is administered to areas of the skin of the animal or in the environment of the animal. The acceptable vehicle can be scented.

Methods to prevent Hematophagous Diptera insects from landing and biting animals comprising administering to animals in need of such treatment or placing in the environment of animals a synthetic insect bite inhibiting semiochemical composition or a synthetic semiochemical solution comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle is another embodiment of the present invention.

Methods to prevent Hematophagous Diptera insects from landing and biting animals comprising administering to animals in need of such treatment or placing in the environment of animals a synthetic insect bite inhibiting semiochemical composition or a synthetic semiochemical solution, said semiochemical composition or semiochemical solution, said composition or solution comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that retain their semiochemical activity and/or their mixtures thereof and an acceptable vehicle is an aspect of the present invention.

In yet another aspect a semiochemical composition or semiochemical solution is provided comprising a synthetic Hematophagous Diptera bite inhibitor semiochemical composition or semiochemical solution comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle to prevent Hematophagous Diptera insects from landing and biting animals.

In yet another aspect the semiochemical composition or semiochemical solution comprising a synthetic Hematophagous Diptera bite inhibitor semiochemical, said semiochemical composition or semichemical solution comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, as described herein, is an ester, an alcohol, a ketone, an amide, an ether, an aldehyde or a sterol derivative of 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their isomers thereof and/or their structural analogs thereof that maintain their semiochemical capabilities and/or their mixtures and an acceptable vehicle to prevent Hematophagous Diptera insects from landing and biting animals.

In yet another aspect a semiochemical composition or semiochemical solution is provided comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle for the fabrication of an insect composition as an insect landing and biting animals preventative to deter Hematophagous Diptera insects from landing and biting animals.

A semiochemical composition or semiochemical solution comprising a synthetic Hematophagous Diptera insect bite inhibiting semiochemical, said semiochemical composition or semiochemical solution comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or comprising 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that maintain their semiochemical capabilities and/or their mixtures thereof and an acceptable vehicle for the fabrication of an insect composition as an insect landing and biting animals preventative to deter Hematophagous Diptera insects from landing and biting animals.

### BRIEF DESCRIPTION OF THE DRAWINGS

FIG. 1 is a photograph of the zone in the abdomen of the guinea pig that was subjected to mosquitoes.

FIG. 2A is a photograph of mosquitoes biting the exposed abdomen of the guinea pig during the experiment in Examples 3 to 6.

FIG. 2B is a photograph of the mosquito bitten area of the guinea pigs immediately after the experiment in Examples 3 to 6.

FIG. 3 is a photograph of a chicken on top of the experimental cage as reflected in Example 7. The mosquitoes are placed in the net underneath the experimental table.

FIG. 4 is a photograph of a horse's ear that has been bitten by Simuliidae as reflected in Example 8.

FIG. 5 is a photograph of arms of a human volunteer with the area subjected to the mosquitoes as reflected in Example 9.

FIG. 6 is a photograph of the apparatus used to test human subjects as reflected in Example 9.

FIG. 7 is a photograph of the testing chamber used on sheep in Example 11.

FIG. 8 is a photograph of one side of a shaven sheep described in Example 11.

### BRIEF DESCRIPTION OF THE PREFERRED EMBODIMENTS

As used herein “semiochemical” means a chemical emitted by a plant or an animal that evokes a behavioral or physiological response in another organism. When the semiochemical affects an individual of the same species, it is called a pheromone. When the semiochemical affects an individual of a different species, it is called an allelochemical.

As used herein “insects” includes all hematophagus insects that have mouth parts and chemical agents for penetrating the vascular structure of the skin of animals. They are commonly known as blood sucking insects which include four main insect orders of diptera, hemiptera, phthiraptera and siphononptera.

By “Hematophagous Diptera insects” is meant insects such as mosquitoes, Family Culicidae, biting midgets, Family Carantopogonidae, tsetse flies, Family Glossinidae, sheep keds, Family Hippoboscidae, table and horn flies, Family Muscidae, sand flies, Family Psychodidae, Subfamily Phlebotominae, snipe flies, Family Rhagionidae, black flies Family Simuliidae and horse flies Family Tabanidae.

As used herein, the term “environment” means surroundings. These surroundings are generally in the vicinity of about 1.5 to about 10 meters.

By “about” is meant ±0.1% (w %).

By “enhancer composition” is meant an active composition that is species-specific in insects and which can be used to enhance or act synergistically with the semiochemical composition to increase the effectiveness in specific species.

When referring to the mixtures of the semiochemical compounds set forth in the present invention means that the composition can include, for example, 3-cyclopentyl 2-methyl propionic acid and a salt of 3-cyclohexyl propionic acid or a derivative of 3-cyclopentyl propionic acid and a structural analogue of 3-cyclohexyl 2-methyl propionic acid or an isomer of 3-cyclopentyl 2-methyl propionic acid and 3-hexyl 2-methyl propionic acid and the like.

“Derivatives,” as used herein, include esters, alcohols, ketones, amides, ethers, aldehydes and sterol derivatives of at least one compound selected from the group of 3-cyclopentyl 2-methyl propionic acid, 3-cyclohexyl 2-methyl propionic acid and methylated cyclohexyl acetic acid or at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid and/or mixtures thereof. These derivatives can replace one or more of the semiochemicals in the composition, as described herein, and have the same effects.

“Isomers” include structural isomerism and spatial isomerism. Structural isomers are isomers that have the same component atoms but are arranged differently from each other. An example of a structural isomer is propyl alcohol and isopropyl alcohol. Spatial isomers contain the same atoms linked in an identical manner in the molecule and differing from each other only in the spatial arrangement of the atoms or groups of atoms. Examples of spatial isomers are glucose and dextrose.

By “structural analogue” is meant a group of chemical compounds similar in structure to that of another one but differing from it in respect of a certain component. A structural analogue can differ in one or more atoms, functional groups or substructures, which are replaced with other atoms, functional groups of substructures. Examples include 3-cyclopentyl-3-oxo-propionic acid ethyl ester, 3 cyclopentyl-2-methoxy propionic acid, 3 cyclopentyl propionic acid methyl ester, 3-cyclohexyl propanamide, 3-cycloheptyl-2-propyl propionic acid and the like.

As used herein the term “acceptable vehicle” means that the semiochemical composition can be formulated in any kind of material such as liposomes, gels, creams, aerosols, towelettes, sprays and solvents. The semiochemical composition can also be encapsulated, placed in a diffuser or in a slow release matrix, or can be placed in molded or extruded polymers, which can be used to make collars or blocks, and can be impregnated in resins or candles. The semiochemical composition can also be formulated in insect repellant wrist bands, in tablecloths, tissue and clothes.

Any type of pleasing scent can be added to the formulations disclosed herein such as lavender, cedar, rose, lemon and the like.

The term “solution” as used herein means a solid or oil that is dispersed in a liquid either by being dissolved or in suspension.

As used herein “at least one” means 1, 2, 3, 4, 5, 6, 7, 8 or 9 semiochemical compounds or cyclic compounds and methylated cyclic compound mixtures or their salts thereof, their derivatives thereof, their isomers thereof and/or their structural analogs thereof that maintain their semiochemical capabilities and/or their mixtures thereof. This term does not exclude additional nonsemiochemical compounds from the composition.

As used herein the term “placing in the environment” means placing the semiochemical composition in surroundings in which the insects may be present. This phrase encompasses, for example, formulations such as candles, wrist band formulations, sprays, impregnated resins, placed in a diffuser or in a slow release matrix, or can be placed in molded or extruded polymers, which can be used to make collars or blocks.

As used herein the term “animal” encompasses “warm blooded animals” and includes birds and mammals.

Examples of birds that can be treated with the compositions and methods of the invention include blue birds, cardinals, doves, eagles, geese, turkeys, chickens, hens, ducks, quails, herons, sparrows, woodpeckers, owls, parrots and the like.

The term “mammal” encompasses any of various warm-blooded vertebrate animals of the class Mammalia, including humans, characterized by a covering of hair on the skin and, in the female, milk-producing mammary glands for nourishing the young. The present invention is not limited to treating humans, but also encompasses veterinary applications, especially since it is well known that animals also can be bitten by Hematophagus Diptera insects.

Examples of mammals that can be treated with the compositions and methods of the present invention include humans, domestic animals such as dogs and cats, horses, mice, goats, deer, cows, rabbits, zoo animals, bears, monkeys, apes, elks, bison, although this invention may be applied to other mammalian species as well.

As used herein “consisting essentially of” means that the compositions of the present invention and as described herein can contain additional additives which do not affect the semiochemical's effective insect repulsive properties.

More specifically, the present invention provides a composition that repels insects which contains a semiochemical that was partially derived from secretions around the jugale area of raccoons (Procyon lotor), viverrine dogs (Nyctereutes procyonoides) or wolverines (Gulo gulo). The secretions are obtained after soft pressure was applied on the sebaceous glands of the jugale area. These secretions were preserved in dichloromethane and acetonitrile and then further analyzed by GC/MS and analyzed via experimentation to determine whether or not they are semiochemicals.

The semiochemical compositions of the present invention comprise semiochemicals that are methylated cyclic acid compounds, as described herein, or mixtures of methylated cyclic compounds and cyclic compounds, as described herein, and are used as an insect preventative in various formulations to deter

Hematophagous Diptera insects from landing and biting animals. They are synthetic semiochemicals.

The semiochemical composition comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle is one aspect of the present invention.

The present invention also provides a semiochemical composition comprising a synthetic Hematophagous Diptera bite inhibitor semiochemical, said composition comprising at least one of the following mixtures of cyclic compounds and methylated cyclic compounds:3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that retain their semiochemical activity and/or their mixtures thereof and an acceptable vehicle.

In another aspect a semiochemical composition comprising a synthetic Hematophagous Diptera bite inhibitor semiochemical composition comprising at least one compound selected from the group of between about 0.01% (w %/w %) to about 10% (w %/w %) 3-cyclopentyl 2-methyl propionic acid, from between about 0.01% (w %/w %) to about 10% (w %/w %) 3-cyclohexyl 2-methyl propionic acid and from between about 0.01% (w %/w %) to about 10% (w %/w %) methylated cyclohexyl acetic acid is provided. Their salts thereof, their derivatives thereof, their isomers thereof and/or their structural analogs thereof that retain their semiochemical activity and/or their mixtures thereof of 3-cyclopentyl 2-methyl propionic acid, 3-cyclohexyl 2-methyl propionic acid or methylated cyclohexyl acetic acid are present in the same amount.

In yet another aspect a semiochemical composition is provided comprising a synthetic Hematophagous Diptera bite inhibitor semiochemical composition comprises at least one compound selected from the group of between about 0.05% (w %/w %) to about 15% (w %/w %) 3-cyclopentyl 2-methyl propionic acid, from between about 0.05% (w %/w %) to about 15% (w %/w %) 3-cyclohexyl 2-methyl propionic acid and from between about 0.05% (w %/w %) to about 15% (w %/w %) methylated cyclohexyl acetic acid. Their salts thereof, their derivatives thereof, their isomers thereof and/or their structural analogs thereof that retain their semiochemical activity and/or their mixtures thereof of 3-cyclopentyl 2-methyl propionic acid, 3-cyclohexyl 2-methyl propionic acid or methylated cyclohexyl acetic acid are present in the same amount.

In another aspect the semiochemical composition comprises at least one of the following mixtures of cyclic compounds and methylated cyclic compounds:the 3-cyclopentyl propionic acid and 3-cyclohexyl 2-methyl propionic is present in the semiochemical compositions in a range of between about 0.01% to about 10% (w %/w %); the 3-cyclopentyl 2-methyl propionic acid and 3-cyclohexyl propionic acid, is present in the semiochemical compositions in a range between about 0.01% to about 10% (w %/w %); the 3-cyclopentyl propionic acid and methylated cyclohexyl acetic acid is present in the semiochemical composition in a range between 0.01% to about 10% (w %/w %); the 3-cyclohexyl propionic acid and methylated cyclohexyl acetic acid is present in the semiochemcal compositions in a range of between about 0.01% to about 10% (w %/w %); the 3-cyclopentyl propionic acid and 3-cyclopentyl 2-methyl propionic acid is present in the semiochemical compositions in a range of between about 0.01% to about 10% (w %/w %); the 3-cyclohexyl propionic acid and 3-cyclohexyl 2-methyl propionic acid is present in the semiochemical compositions in a range of between about 0.01% to about 10% (w %/w %); the cyclohexyl acetic acid and methylated cyclohexyl acetic acid is present in the semiochemical compositions in a range of between about 0.01% to about 10% (w %/w %); the 3-cyclopentyl 2-methyl propionic acid and cyclohexyl acetic acid is present in the semiochemical compositions in a range of between about 0.01% to about 10% (w %/w %); and the 3-cyclohexyl 2-methyl propionic acid and cyclohexyl acetic acid is present in the semiochemical compositions in a range of between about 0.01% to about 10% (w %/w %). Their salts thereof, their derivatives thereof, their isomers thereof and/or their structural analogs thereof that retain their semiochemical activity and/or their mixtures thereof comprising at least one of the following mixtures of cyclic compounds and methylated cyclic compounds: of 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid are present in the same amount as described above.

In another embodiment the semiochemical composition comprises at least one of the following mixtures of cyclic compounds and methylated cyclic compounds:The 3-cyclopentyl propionic acid and 3-cyclohexyl 2-methyl propionic is present in the semiochemical compositions in a range of between about 0.05% to about 15% (w %/w %); the 3-cyclopentyl 2-methyl propionic acid and 3-cyclohexyl propionic acid, is present in the semiochemical compositions in a range between about 0.05% to about 15% (w %/w %); the 3-cyclopentyl propionic acid and methylated cyclohexyl acetic acid is present in the semiochemical composition in a range between about 0.05% to about 15% (w %/w %); the 3-cyclohexyl propionic acid and methylated cyclohexyl acetic acid is present in the semiochemcal compositions in a range of between about 0.05% to about 15% (w %/w %); the 3-cyclopentyl propionic acid and 3-cyclopentyl 2-methyl propionic acid is present in the semiochemical compositions in a range of between about 0.05% to about 15% (w %/w %)); the 3-cyclohexyl propionic acid and 3-cyclohexyl 2-methyl propionic acid is present in the semiochemical compositions in a range of between about 0.05% to about 15% (w %/w %); the cyclohexyl acetic acid and methylated cyclohexyl acetic acid is present in the semiochemical compositions in a range of between about 0.05% to about 15% (w %/w %); the 3-cyclopentyl 2-methyl propionic acid and cyclohexyl acetic acid is present in the semiochemical compositions in a range of between about 0.05% to about 15% (w %/w %); and the 3-cyclohexyl 2-methyl propionic acid and cyclohexyl acetic acid is present in the semiochemical compositions in a range of between about 0.05% to about 15% (w %/w %). Their salts thereof, their derivatives thereof, their isomers thereof and/or their structural analogs thereof that retain their semiochemical activity and/or their mixtures thereof comprising at least one of the following mixtures of cyclic compounds and methylated cyclic compounds:of 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylayed cyclohexyl acetic acid or 3-cyclopentyl 2-methyl propionic acid and cyclohexyl acetic acid or 3-cyclohexyl 2-methyl propionic acid and cyclohexyl acetic acid are present in the semiochemical composition in the same amounts as described above; in a range of between about 0.05% to about 15% (w %/w %),

The acceptable vehicle, as described herein, is a pharmaceutically acceptable vehicle or a veterinarian acceptable vehicle. It includes solvents, dispersion media, absorption delaying agents and the like. These pharmaceutically acceptable vehicles are described in Remington's Pharmaceutical Sciences 21^{st} edition 2005. An acceptable vehicle can be, for example, glycol ethers or physiological saline. The acceptable vehicle will vary with the way the semiochemical composition is formulated. It can be added to the at least one compound selected from the group of 3-cyclopentyl 2-methyl propionic acid, 3-cyclohexyl 2-methyl propionic acid and methylated cyclohexyl acetic acid their salts thereof, their derivatives thereof, their isomers thereof and/or their structural analogs thereof that retain their semiochemical activity and/or their mixtures thereof or at least one of the following mixtures of cyclic compounds and methylated cyclic compounds:3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid their salts thereof, their derivatives thereof, their isomers thereof and/or their structural analogs thereof that retain their semiochemical activity and/or their mixtures thereof during formulation.

The pharmaceutically acceptable salts of the semiochemical composition, described herein, include those that are organic or inorganic salts of at least one compound selected from the group of 3-cyclopentyl 2-methyl propionic acid, 3-cyclohexyl 2-methyl propionic acid and methylated cyclohexyl acetic acid or at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid. These are well known and described in the Physician's Desk Reference, The Merck Index and Goodman and Gilman's The Pharmacological Basis of Therapeutics. The pharmaceutically acceptable salts are, for example, sodium, potassium, ammonium, calcium and magnesium and salts formed with inorganic acids such as hydrochloric acid, hydrobromic acid, phosphoric acid, sulfuric acid and the like or salts formed with organic acids such as oxalic acid, fumaric acid, tartaric acid, malonic acid, acetic acid, citric acid, benzoic acid and the like.

The semiochemical composition comprising a synthetic Hematophagous Diptera bite inhibitor semiochemical, said composition comprising at least one compound selected from the group of 3-cyclopentyl 2-methyl propionic acid, 3-cyclohexyl 2-methyl propionic acid and methylated cyclohexyl acetic acid or at least one of the following mixtures of cyclic compounds and methylated cyclic compounds:3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that retain their semiochemical activity and/or their mixtures thereof and an acceptable vehicle can further comprise a nontoxic filler or an enhancer composition. The nontoxic filler is selected from the group of fatty acids, alcohols, amines, squalene, glycerol and mixtures thereof, while the enhancer composition contains amines and fatty acids from indolic derivatives, esters of these amines and fatty acids, ketones, acetone, alcohols or sterols.

In yet another aspect the semiochemical composition comprising a synthetic Hematophagous Diptera bite inhibitor semiochemical, said composition is an ester, an alcohol, a ketone, an amide, an ether, an aldehyde or a sterol derivative of at least one compound selected from the group of 3-cyclopentyl 2-methyl propionic acid, 3-cyclohexyl 2-methyl propionic acid and methylated cyclohexyl acetic acid or at least one of the following mixtures of cyclic compounds and methylated cyclic compounds:3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, as described herein, their salts thereof, their isomers thereof and/or their structural analogs thereof that maintain their semiochemical capabilities to prevent Hematophagous Diptera insects from landing and biting animals and/or their mixtures and an acceptable vehicle.

The semiochemical composition, as described herein, can be in the form of powders, tablets, pellets, capsules, granulated, granulated particles, dry flakes or other forms suitable for use. The composition can then be diluted in a suitable solvent. It can then be administered to areas of the skin of the animal or in the environment of the animal.

A solution or solutions containing the composition comprising a Hematophagous Diptera bite inhibitor semiochemical, said composition comprising at least one compound selected from the group of 3-cyclopentyl 2-methyl propionic acid, 3-cyclohexyl 2-methyl propionic acid and methylated cyclohexyl acetic acid or at least one of the following mixtures of cyclic compounds and methylated cyclic compounds:3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their isomers thereof and/or their structural analogs thereof that maintain their semiochemical capabilities and/or their mixtures is another aspect of the invention. The solutions can be formulated with an acceptable vehicle such as a pharmaceutically acceptable vehicle or a pharmaceutically acceptable vehicle.

In another aspect the semiochemical solution comprising a synthetic Hematophagous Diptera bite inhibitor semiochemical composition comprises at least one compound selected from the group of between about 0.01% (w %/w %) to about 10% (w %/w %) 3-cyclopentyl 2-methyl propionic acid, from between about 0.01% (w %/w %) to about 10% (w %/w %) 3-cyclohexyl 2-methyl propionic acid and from between about 0.01% (w %/w %) to about 10% (w %/w %) methylated cyclohexyl acetic acid. Their salts thereof, their derivatives thereof, their isomers thereof and/or their structural analogs thereof that retain their semiochemical activity and/or their mixtures thereof of 3-cyclopentyl 2-methyl propionic acid, 3-cyclohexyl 2-methyl propionic acid or methylated cyclohexyl acetic acid are present in the same amount.

The semiochemical solution comprising a synthetic Hematophagous Diptera bite inhibitor semiochemical composition comprises at least one compound selected from the group of between about 0.05% (w %/w %) to about 15% (w %/w %) 3-cyclopentyl 2-methyl propionic acid, from between about 0.05% (w %/w %) to about 15% (w %/w %) 3-cyclohexyl 2-methyl propionic acid and from between about 0.05% (w %/w %) to about 15% (w %/w %) methylated cyclohexyl acetic acid is yet another embodiment of the present invention. Their salts thereof, their derivatives thereof, their isomers thereof and/or their structural analogs thereof that retain their semiochemical activity and/or their mixtures thereof of 3-cyclopentyl 2-methyl propionic acid, 3-cyclohexyl 2-methyl propionic acid or methylated cyclohexyl acetic acid are present in the same amount.

In another aspect the semiochemical solution comprising a synthetic Hematophagous Diptera bite inhibitor semiochemical composition comprising at least one of the following mixtures of cyclic compounds and methylated cyclic compounds:the 3-cyclopentyl propionic acid and 3-cyclohexyl 2-methyl propionic, is present in a range of between about 0.01% to about 10% (w %/w %); the 3-cyclopentyl 2-methyl propionic acid and 3-cyclohexyl propionic acid is present in the semiochemical compositions in a range between about 0.01% to about 10% (w %/w %); the 3-cyclopentyl propionic acid and methylated cyclohexyl acetic acid, is present in the semiochemical composition in a range between 0.01% to about 10% (w %/w %); the 3-cyclohexyl propionic acid and methylated cyclohexyl acetic acid, is present in the semiochemical compositions in a range of between about 0.01% to about 10% (w %/w %); the 3-cyclopentyl propionic acid and 3-cyclopentyl 2-methyl propionic acid is present in the semiochemical compositions in a range of between about 0.01% to about 10% (w %/w %); the 3-cyclohexyl propionic acid and 3-cyclohexyl 2-methyl propionic acid is present in the semiochemical compositions in a range of between about 0.01% to about 10% (w %/w %); the cyclohexyl acetic acid and methylated cyclohexyl acetic acid is present in the semiochemical compositions in a range of between about 0.01% to about 10% (w %/w %); the 3-cyclopentyl 2-methyl propionic acid and cyclohexyl acetic acid is present in the semiochemical compositions in a range of between about 0.01% to about 10% (w %/w %); and the 3-cyclohexyl 2-methyl propionic acid and cyclohexyl acetic acid is present in the semiochemical compositions in a range of between about 0.01% to about 10% (w %/w %) is yet another aspect of the present invention. Their salts thereof, their derivatives thereof, their isomers thereof and/or their structural analogs thereof that retain their semiochemical activity and/or their mixtures thereof are present in the same amount in the semiochemical compositions as described above; i.e., in a range of between about 0.01% to about 10% (w %/w %).

In another aspect the semiochemical solution comprising a synthetic Hematophagous Diptera bite inhibitor semiochemical composition comprises at least one of the following mixtures of cyclic compounds and methylated cyclic compounds: the 3-cyclopentyl propionic acid and 3-cyclohexyl 2-methyl propionic, is present in the semiochemical compositions in a range of between about 0.05% to about 15% (w %/w %); the 3-cyclopentyl 2-methyl propionic acid and 3-cyclohexyl propionic acid, is present in the semiochemical compositions in a range between about 0.05% to about 15% (w %/w %); the 3-cyclopentyl propionic acid and methylated cyclohexyl acetic acid is present in the semiochemical compositions in a range between 0.05% to about 15% (w %/w %); the 3-cyclohexyl propionic acid and methylated cyclohexyl acetic acid is present in the semiochemcal compositions in a range of between about 0.05% to about 15% (w %/w %); the 3-cyclopentyl propionic acid and 3-cyclopentyl 2-methyl propionic acid is present in the semiochemical compositions in a range of between about 0.05% to about 15% (w %/w %); the 3-cyclohexyl propionic acid and 3-cyclohexyl 2-methyl propionic acid is present in the semiochemical compositions in a range of between about 0.05% to about 15% (w %/w %); the cyclohexyl acetic acid and methylated cyclohexyl acetic acid is present in the semiochemical compositions in a range of between about 0.05% to about 15% (w %/w %); and the 3-cyclopentyl 2-methyl propionic acid and cyclohexyl acetic acid is present in the semiochemical compositions in a range of between about 0.05% to about 15% (w %/w %); and the 3-cyclohexyl 2-methyl propionic acid and cyclohexyl acetic acid is present in the semiochemical compositions in a range of between about 0.05% to about 15% (w %/w %). The salts thereof, derivatives thereof, isomers thereof and/or structural analogs thereof that retain their semiochemical activity and/or mixtures thereof are present in the semiochemical compositions in same amount as described above; in a range of between about 0.05% to about 15% (w %/w %).

The solutions can also contain a nontoxic filler, as described herein, or an enhancer composition, as described herein. Derivatives are also encompassed in the solutions and are described herein.

The semiochemical solution in the acceptable vehicle, as described herein, can be in the form of a diffuser, a spray, an aerosol, an emulsion, a suspension, in the form of drops, a towelette, a cream, a shampoo, soap, a lotion, a gel, a microencapsulated spray, a granulated resin, an extruded polymer, injected polymer or molded polymer in the form of a collar, a candle or in a slow release matrix, in insect repellant wrist bands, in tablecloths, tissue, microporous catridges having membranes for passive diffusion and clothes. It is administered to areas of the skin of the animal or in the environment of the animal. The acceptable vehicle can be scented.

The solutions, containing the semiochemical compositions, as described herein, can also be formulated in sprays or aerosols. The solutions can be microencapsulated, can be placed in liposomes, can be placed in microparticles, polymers, gels or in a slow release matrix. The insect preventative solution can be placed in candles or can be released through an electronic vaporization or diffuser.

More specifically, the solutions containing the semiochemical compositions, as described herein, at a concentration between about 0.1% to about 10% (w %/w %) can be formulated in liquid paraffin and used in an electric diffuser. These diffusers are known in the art as illustrated, for example, in the product Adaptil® diffuser, which works like a plug in air refreshener, continuously releasing the composition into the environment.

In another aspect the present invention provides a non-electric diffuser, which slowly disperses the semiochemical compositions or semiochemical solutions, as described herein. In this type of diffuser the semiochemical solution is dispersed in a resin such as polyolefins acrylic resins, MATERBI®, any resins and the like, at a concentration between about 2% to about 10% (w %/w %) and forms a solid material that can be further shaped in the form of blocks, circles, ovals etc.

In yet another aspect between about 5% to 12% (w %/w %) concentration of the semiochemical solutions, as described herein, can be formulated in paraffin which solidifies forming a candle.

A liquid dispensing device is also part of the present invention such as those disclosed in U.S. Pat. No. 5,242,111. In this formulation between about 2% to about 10% (w %/w %) of the semiochemical solution, as described herein, is used in such a device.

A spray aerosol under pressure with a mechanism that can be programmed to spray a specific amount of the semiochemical solution also forms another aspect of the present invention. In this aspect the concentration of the semiochemical solutions, as described herein, is between about 1% to about 4% (w %/w %).

Besides block diffusers the semiochemical solutions, as described herein, can also be formulated in cosmetic products such as in creams, lotions, gels, bath gels, as towelettes, soap and shampoos.

In this regard, from between about 0.05% to about 4% (w %/w %) of the semiochemical solution of the present invention is combined with surfactants such as ammonium lauryl sulfate, triethanolamine lauryl sulfate, as well as other ingredients such as thickeners, preservatives, emulsifiers and the like to produce shampoos. The methods to make shampoos are well known in the art as evidenced by U.S. Pat. Nos. 6,759,051 and 6,743,760.

Gels and shower/bath gels can be obtained by combining between about 0.05% to about 4% (w %/w %) of the semiochemical solution of the present invention with either a surfactant and carboxy polymethylene (carbomer) for the bath gel or only carbomer for the gel.

An aqueous spray can be prepared by combining between about 0.05% to about 4% (w %/w %) of the semiochemical solution, water and a surfactant.

Creams are also encompassed by the present invention and are obtained by combining between about 0.05% to about 4% (w %/w %) of the semiochemical solution of the present invention in an emulsion.

In yet another aspect the semiochemical solution of the present invention can be formulated with an alcohol to be used in a lotion or placed on a towelette. In this aspect the lotion is formulated with ethanol and water and can be used also as a spray and in this embodiment the semiochemical solution is generally in a concentration of between about 0.01% to about 4% (w %/w %). For impregnating the semiochemical solution on a towelette, generally between about 0.05% to about 4% (w %/w %) of the semiochemical solution of the present invention is used.

The semiochemical solution of the present invention can also be formulated in a polymer or impregnated in a resin and can be molded, injected or extruded into a variety of shapes and objects such as collars for animals, granules for use in containers, thin layers that can be encased with, for example, plastic or cardboard. For a molded, extruded, injected or resin impregnated polymer any polymer can be used in this formulation that can retain the desired shape and emit into the atmosphere the semiochemical composition of the present invention.

In one aspect of the present invention a combination of polyvinyl chloride and polyurethane polymer is used, the polymer is molded and the concentration of the semiochemical solution added to the polymer is between about 0.05% to about 4% (w %/w %).

In another aspect only polyvinyl chloride is used, the polymer is extruded and the concentration of the semiochemical solution added to the polymer is between about 0.05% to about 4% (w %/w %).

A resin impregnated with between about 0.5% to about 10% (w %/w %) of the semiochemical solution of the present invention is also encompassed by the present invention. In this regard, the polymer composition is polyvinyl chloride, MATER-BI®, which is a starched based polymer is used and the composition is granulated.

In yet another aspect the present invention encompasses microencapsulated sprays that can be used outdoors, around pools and patios. This spray is composed of water, surfactant and microcapsules and contains between about 5% to about 20% (w %/w %) of the semiochemical solution of the present invention.

The present invention can also be formulated for veterinary use. In this aspect the semiochemical solution is formulated with a skin absorption enhancer such as azone, oleic acid, ethanol, glycols such as propylene glycols, DPPG, fatty acids and esters such as Labrasol, Labrafil®, Hydrophile and transcutol. The semiochemical solution is generally present in a concentration of between about 0.005% to about 4% (w %/w %).

The semiochemical product for veterinary use can be placed in an applicator and used as a spot-on, line-on or a liquid that can be poured onto the animal. It can be also in the form of a spray or in a liquid form that can be used as a dip.

The semiochemical composition of the present invention can also be encapsulated, using methods known in the art such as via spray cooling, coacervation, polymerization, phase separation, solvent evaporation, coextrusion, fluidized bed, disk and the like. The composition can be encapsulated using hexadecanol, gelatin and gum, a polysachharide such as Chitosan® or silicate.

Alternatively the solutions of the present invention can be simply diluted in a solvent and applied to various areas manually such as with a brush or sponge.

Different scents can be added to the above formulations such as lavender, cedar, rose lemon and the like.

Methods to prevent Hematophagous Diptera insects from landing and biting animals comprising administering to animals in need of such treatment or placing in the environment of animals a synthetic insect bite inhibiting semiochemical composition or a synthetic semiochemical solution comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid their salts thereof, their derivatives thereof, their isomers thereof and/or their structural analogs thereof that retain their semiochemical activity and/or their mixtures thereof and an acceptable vehicle is another embodiment of the present invention.

In another aspect methods to prevent Hematophagous Diptera insects from landing and biting animals comprising administering to animals in need of such treatment or placing in the environment of animals an insect bite inhibiting semiochemical composition or semiochemical solution comprising a synthetic Hematophagous Diptera bite inhibitor semiochemical, said semiochemical composition or semiochemical solution comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that retain their semiochemical activity and/or their mixtures thereof and an acceptable vehicle is an aspect of the present invention.

The amounts of at least one compound selected from 3-cyclopentyl 2-methyl propionic acid, 3-cyclohexyl 2-methyl propionic acid and methylated cyclohexyl acetic acid or at least one of the following mixtures of cyclic compounds and methylated cyclic compounds:3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid their salts thereof, derivatives thereof, isomers thereof and/or structural analogs thereof that retain their semiochemical activity and/or mixtures thereof to be used in the methods are described herein and are the same amounts as those described herein for the semiochemical compositions or semiochemical solutions.

A semiochemical composition or semiochemical solution is provided comprising a synthetic Hematophagous Diptera bite inhibitor semiochemical, said semiochemical composition or semiochemical solution comprising at least one compound selected from the group of 3-cyclopentyl 2-methyl propionic acid, 3-cyclohexyl 2-methyl propionic acid and methylated cyclohexyl acetic acid, salts thereof, derivatives thereof, isomers thereof and/or structural analogs thereof that maintain their semiochemical capabilities and/or mixtures thereof and an acceptable vehicle for use in preventing Hematophagous Diptera insects from landing and biting animals.

A semiochemical composition or semiochemical solution comprising a comprising a synthetic Hematophagous Diptera bite inhibitor semiochemical, said semiochemical composition or semiochemical solution comprising at least one of the following mixtures of cyclic compounds and methylated cyclic compounds:3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that maintain their semiochemical capabilities and/or their mixtures thereof and an acceptable vehicle for use in preventing Hematophagous Diptera insects from landing and biting animals is another aspect of the invention.

The amounts of at least one compound selected from the group of 3-cyclopentyl 2-methyl propionic acid, 3-cyclohexyl 2-methyl propionic acid and methylated cyclohexyl acetic acid or at least one of the following mixtures of cyclic compounds and methylated cyclic compounds:3-cyclopentyl 2-methyl propionic acid and 3-cyclohexyl propionic acid or 3-cyclohexyl propionic acid and 3-cyclohexyl 2-methyl propionic acid or 3-cyclopentyl propionic acid and methylated cyclohexyl acetic acid or 3-cyclohexyl propionic acid and methylated cyclohexyl acetic or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, derivatives thereof, isomers thereof and/or structural analogs thereof that retain their semiochemical activity and/or mixtures thereof to be used in preventing Hematophagous Diptera insects from landing and biting animals are described herein and are the same as those described herein for the semiochemical compositions or semiochemical solutions.

A semiochemical composition or semiochemical solution comprising a synthetic Hematophagous Diptera insect bite inhibiting semiochemical, said semiochemical composition or semiochemical solution comprising at least one compound selected from the group of 3-cyclopentyl 2-methyl propionic acid, 3-cyclohexyl 2-methyl propionic acid and methylated cyclohexyl acetic acid, salts thereof, derivatives thereof, isomers thereof and/or structural analogs thereof that maintain their semiochemical capabilities and/or mixtures thereof and an acceptable vehicle for the fabrication of an insect composition as an insect landing and biting animals preventative to deter Hematophagous Diptera insects from landing and biting animals.

In another aspect a semiochemical composition or semiochemical solution is provided comprising a synthetic Hematophagous Diptera bite inhibitor semiochemical, said semiochemical composition or semiochemical solution comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that maintain their semiochemical capabilities and/or their mixtures thereof and an acceptable vehicle for the fabrication of an insect composition as an insect landing and biting animals preventative to deter Hematophagous Diptera insects from landing and biting animals.

Derivatives of the semiochemical composition or semiochemical solution comprising at least one compound selected from the group of 3-cyclopentyl 2-methyl propionic acid, 3-cyclohexyl 2-methyl propionic acid and methylated cyclohexyl acetic acid or at least one of the following mixtures of cyclic compounds and methylated cyclic compounds:3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, as described herein, can also be utilized in the semiochemical composition or semiochemical solution such as esters, aldehydes, ketones, amides, alcohols or salts of these semiochemical compositions for the fabrication of the insect composition as an insect landing and biting animals preventative, as described herein.

The amounts of at least one compound selected from the group of 3-cyclopentyl 2-methyl propionic acid, 3-cyclohexyl 2-methyl propionic acid and methylated cyclohexyl acetic acid or at least one of the following mixtures of cyclic compounds and methylated cyclic compounds:3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that retain their semiochemical activity and/or their mixtures thereof to be used in the for the fabrication of the insect composition as an insect landing and biting animals preventative are those described herein and are the same as those described herein for the semiochemical compositions or semiochemical solutions.

An enhancer composition containing between 3% to 40% (w %/w %) can also be added to the semiochemical composition or semiochemical solution, as described herein, if desired. This enhancer composition comprises volatile organic compounds and mixtures of these compounds. This enhancer compound may be species-specific in nature and may vary according to the insect species for which the composition is used.

The compounds that can be used in the enhancer composition include, but are not limited to, amines, fatty acids from indolic derivatives, esters of these amines and fatty acids, ketones such as acetone, alcohols, sterols and the like.

Nontoxic fillers can also be added to the semiochemical composition or semiochemical solution, as described herein, which include fatty acids, alcohols, amines, squalene and glycerol.

The cyclic methylated and unmethylated proprionic acids are generally liquid in nature and can be diluted in various solvents in which these compounds are miscible. These solvents include, for example, ethanol, benzene, propyl alcohol, propylene glycol, isopropanol, chloroform, absolute ethanol, volatile oils, paraffin, ethyl ether, Tween®, glycerol, Benecel™, transcutol, mixtures thereof and the like.

In a very general aspect the semiochemical compositions or semiochemical solutions, as formulated herein, of the present invention can be used to prevent insects from landing and biting animals in a variety of environmental surroundings. These include, but are not limited to, areas where the insects are attracted such as around food, tables, water such as by a pool or on the beach and various flowerbeds.

In another embodiment the method comprises encapsulating at least one of the above-mentioned semiochemical compositions or semiochemical solutions and placing the encapsulated semiochemical composition or semichemical solution in the environment as an insect landing and biting animals preventative to deter insects.

In another embodiment the method comprises electronically diffusing at least one of the above-mentioned semiochemical compositions or semiochemical solutions, as described herein, in the environment to deter insects.

In yet another embodiment the present invention relates to a method of repelling insects wherein a candle containing at least one of the above-mentioned semiochemical compositions or semiochemical solutions, as described herein, is placed in the environment to deter insects.

In yet another embodiment of the present invention provides a method for repelling insects by placing on an animal or in their environment at least one of the above-mentioned semiochemical compositions or semiochemical solutions, as described herein.

In order to fully illustrate the present invention and the advantages thereof, the following specific examples are given, it being understood that the same are intended only as illustrative and in nowise limitative.

### EXAMPLES

### Example 1

### Analysis of Skin Secretions from Raccoon (Procyon Lotor), Viverine Dog (Nyctereutes Procyonoides) and Wolverine (Gulo Gulo)

The animals used in this example were obtained from zoos and/or animal rescue centers and sampled after tranquilization.

5 raccoons, 5 viverine dogs and 5 wolverines were tranquilized and skin secretions were taken using sterilized non-woven cellulose compresses.

Samples were taken from secretions around the zygomatic bone (jugale). The samples were then placed in flasks that contained dichloromethane and acetonitrile and were numbered and labeled with the specific animal from which they were taken.

### Example 2

### Chemical Analysis of the Secretions

The secretions were further analyzed using gas chromatography and mass spectroscopy at positive electronics (EI+) and with an energy at 70 eV at 180° C. This technique was used to fragment the molecules present in the secretion in a manner that was reproducible and sensitive.

The following steps were undertaken to prepare the samples:

The samples that were present on the non-woven compresses that were obtained by rubbing the zygomatic bone (jugale) region of the raccoons, viverine dogs and wolverines were obtained using fine latex gloves so as not to contaminate the compress with human secretions.

The compresses were placed in glass flasks containing 10 ml of acetonitrile and 10 ml of dichloromethane that was the solvent used for desorption. The use of acetonitrile also prevented bacterial growth and the samples could be stored for a long time.

In a first experiment, the samples were analyzed individually for each secretion obtained. If the sample revealed that one composition was not really concentrated in the sample and directly identifiable, the samples were then pooled.

Each sample was then evaporated under a stream of azote to achieve a volume of 2 ml. 2.0 μl samples were injected and then analyzed using a GC/MS chromatograph GC 8000® of Fisions Instruments. The mass spectroscopy was performed on a Fisons Instruments VG Quattro®. A JW column of DB1 having a length of 30 m: id=0.25 mm: film=0.25 μm were used during this analysis. The following parameters were also used: Split: 1/20 Split/Splitless 45 seconds.

The results were analyzed using a data base to obtain the most probable spectrums. Data bases containing such data are well known in the art.

The following chemicals were found in the secretions, which are set forth in Table 1 below.

TABLE 1

| CHEMICAL COMPOSITION | PERCENTAGE (w %/w %) |
|---|---|
| 3-cyclopentyl propionic acid | 22% to 35% |
| 3-cyclohexyl propionic acid | 23.5% to 34% |
| 3-cyclopentyl 2-methyl propionic acid | 22.5% to 31% |
| 3-cyclohexyl 2-methyl propionic acid | 21% to 33.5% |

### Example 3

### Experimental Testing of the Efficacy-In Guinea Pigs

The tests were undertaken using experimental cages, which were composed of a plastic frame having the dimensions 29×29×29 cm. A sleeve of mosquito netting was placed over the cage. The sleeves of the netting were closed with rubber bands thus preventing light from entering the cages.

In each cage the mosquitoes had at their disposition a little water placed in a jar. The cages had a code placed on each for identification purposes.

The mosquitoes that were used in this experiment were Culex pipiens quinquefasciatus. In each cage 50 female mosquitoes were introduced. These mosquitoes were all bred in the same environment and had a post-emergence age between 14 and 21 days. The mosquitoes never had a blood meal.

The day before the test 50 images female mosquitoes were introduced into their experimental cage. The mosquitoes were deprived of a source of sugar at least twelve hours before the test.

The mosquitoes were collected by suction on the walls of the experimental cage with a mouth vacuum that was connected to a suction pump. To avoid errors, the mosquitoes were removed and introduced in lots of five. The sex was determined by observation of their antennas, since the male's antennas are more feathery.

Once the mouth vacuum was empty in the experimental cage the health of the mosquitoes was verified. To be used in the experiment, the mosquitoes had to be able to fly. Before the test the dead mosquitoes or those mosquitoes that could not fly were replaced with healthy ones.

Prior to starting the experiment the mosquitoes were tested to determine if the mosquitoes were ready to bite. This was verified by introducing a hand washed with soap and without any smell in the experimental cage. If more than three mosquitoes posed on the hand voluntarily within a delay of 30 seconds, then it was deemed that the mosquitoes were ready to bite. The hand was withdrawn when the three mosquitoes posed on it or when the 30 second time period was up. This test was repeated every minute for a maximum of 5 minutes, until a positive result was obtained. If no positive result was obtained the experiment was postponed.

A herd of guinea pigs males and females aging from 4 months to 3 years were used in the experiments. The guinea pig was anesthetized by injecting 1 mg/kg (live weight) of Zoletil® 20 in the thigh. A thin layer of Ocryl® gel was placed on the eyes of the guinea pigs.

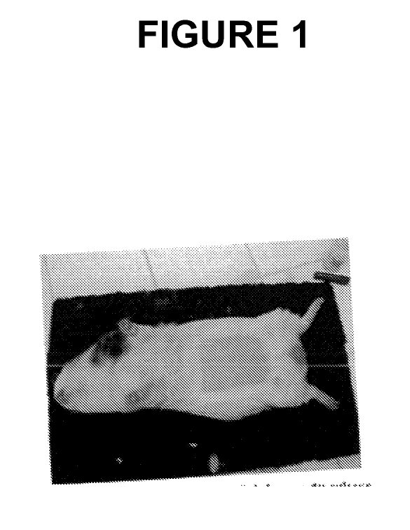

The abdominal zone of the guinea pigs were carefully shaved from the teats to the base of the thorax. The area that was shaved was 8 cm from the base of the thorax to the teats by 6 cm from left to right of the guinea pig. This was done using a transparent template. The shaved area of the guinea pig is shown in FIG. 1.

After shaking the sprayer containing the insect bite inhibiting semiochemical, each guinea pig was sprayed 3 times (0.5 ml total) in the center of the shaved region. After the first administration, the product was spread with the little finger, in which the hand is covered by a vinyl glove, towards the teats. After the second administration by spraying the product was spread with the gloved little finger towards the thorax. After the third administration by spraying the product was spread over the entire shaved surface. The product was permitted to dry for a period of five minutes. The type of treatment was noted for each guinea pig.

At the bottom of the experimental cage a transparent sheet was placed in which a rectangle of 7 cm by 5 cm was cut in the center. Another cover sheet cut with the same dimensions as the transparent sheet was made and the two rectangles were superimposed on one another and stapled together with 8 staples.

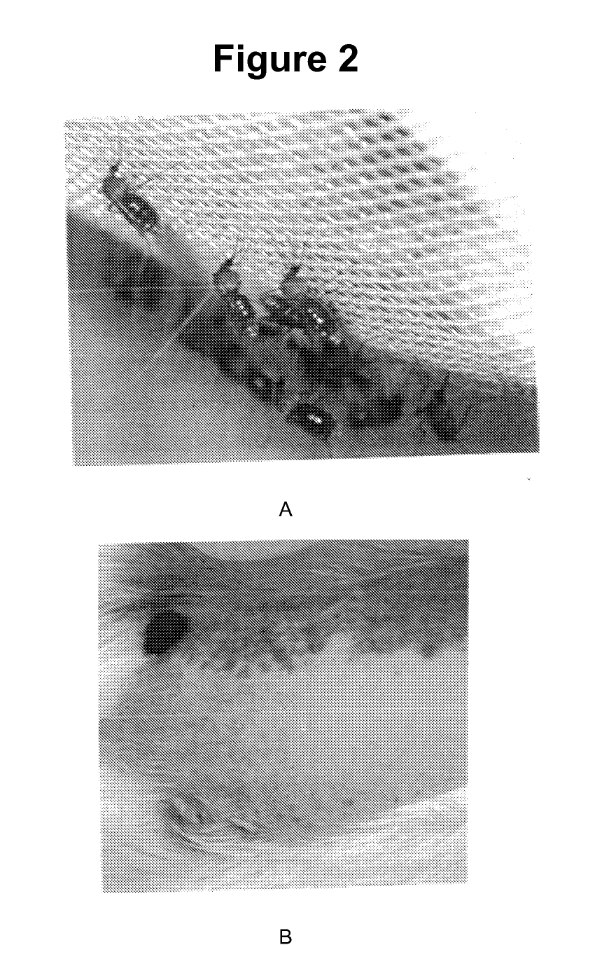

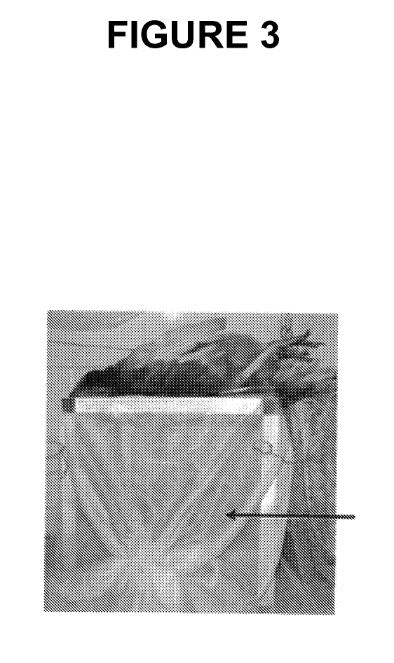

The guinea pig was placed on its back underneath the experimental cage that contained the mosquitoes that did not yet feed on blood and tested for their motivation to bite. The shaved zone of the guinea pig was centered over the rectangular transparent sheet and the guinea pigs were exposed to the mosquitoes for 30 minutes. See, FIGS. 2 and 3.

At the end of 30 minutes, the mosquitoes were recovered by mouth vacuum. They were then enclosed in a plastic bag that contained a paper soaked with ethyl acetate. After 3 minutes the mosquitoes were aligned on a strip of scotch tape that was labeled with the number of the experiment, the date, the name of the guinea pig in the experiment and the treatment that was applied.

Each treatment was tested with a control. In the case of the treatments with solution, the control was the excipient, which was a mixture of Tween®, glycerol and water.

The engorgement of each mosquito was observed under a microscope and was assigned the following three categories:

No engorgement—there was no blood in the abdomen.

Partial engorgement—there was ¼ of the abdomen filled with blood.

Full engorgement—there was more than ¼ of the abdomen filled with blood.

After each experiment the shaved part of guinea pig was cleaned with soap having no odor and rinsed. The netting on each experimental cage of the mosquitoes was washed in a machine. Between two tests the guinea pigs had at least one week of rest before being used again.

The following results are shown in Table 2.

TABLE 2

| | | | concentration | | | % | % | |
|---|---|---|---|---|---|---|---|---|
| Assay | Code | Active | of the | Dose | Number | bites | bites | % |
| code | solution | Principle | solution | μg/cm² | tested | control | tested | efficacy |
| Scr001- | A | WRA | 3.0% | 313 | 12 | 33 | 1 | 97% |
| 01 | | | | | | | | |
| Scr001- | A | WRA 1sem | 3.0% | 313 | 4 | 65 | 60 | 8% |
| 02a | | | | | | | | |
| Scr001- | A | WRA 2sem | 3.0% | 313 | 4 | 65 | 80 | −23% |
| 02b | | | | | | | | |
| Scr001- | B | Lavander | 3.0% | 313 | 4 | 23 | 0 | 100% |
| 03 | | | | | | | | |
| Scr001- | C | geraniol | 3.0% | 31 | 4 | 36 | 0 | 100% |
| 04 | | | | | | | | |
| Scr001- | A | WRA | 0.3% | 31 | 4 | 65 | 17 | 74% |
| 05 | | | | | | | | |
| Scr001- | B | lavender | 0.3% | 31 | 4 | 64 | 29 | 55% |
| 06 | | | | | | | | |
| Scr001- | C | geraniol | 0.3% | 31 | 4 | 60 | 25 | 58% |
| 07 | | | | | | | | |
| Scr001- | D | 3-CPP | 0.3% | 31 | 8 | 64 | 4 | 94% |
| 08 | | | | | | | | |
| Scr001- | E | CHA | 0.3% | 31 | 16 | 59 | 8 | 86% |
| 09 | | | | | | | | |
| Scr001- | F | 3-CHP | 0.3% | 31 | 16 | 47 | 10 | 79% |
| 10 | | | | | | | | |
| Scr001- | G | Toile | 0.4% | 42 | 4 | 70 | 67 | 4% |
| 11 | | pholcus | | | | | | |
| Scr001- | H | Vit. B1 | 0.1% | — | 4 | 95 | 93 | 2% |
| 12 | | | | | | | | |
| Scr001- | G | Toile | 0.4% | 42 | 12 | 78 | 73 | 6% |
| 13 | | pholcus | | | | | | |
| Scr001- | I | Vit. B6 | 0.1% | — | 4 | 73 | 87 | −19% |
| 14 | | | | | | | | |
| Scr001- | G | Toile | 100% | — | 8 | 38 | 26 | 32% |
| 15 | | pholcus | | | | | | |
| Scr001- | DI | 3-CPP | 0.3% | 31 | 16 | 33 | 5 | 85% |
| 16 | | | | | | | | |
| Scr001- | J | Lavander | 3.0% | 313 | 4 | 9 | 0 | 100% |
| 17 | | augustifolia | | | | | | |
| Scr001- | D | 3-CPP | 0.3% | 31 | 6 | 11 | 1 | 91% |
| 18 | | | | | | | | |
| Scr001- | D | 3-CPP | 0.3% | 33 | 6 | 21 | 0 | 100% |
| 19 | | | | | | | | |
| Scr001- | J | Lavander | 3.0% | 313 | 8 | 15 | 1 | 97% |
| 20 | | angustifolia | | | | | | |
| Scr001- | D | 3-CPP | 3.0% | 324 | 16 | 39 | 0 | 100% |
| 21 | | | | | | | | |
| Scr001- | J | Lavander | 0.3% | 31 | 4 | 52 | 15 | 71% |
| 22 | | angustifolia | | | | | | |
| Scr001- | D | 3-CPP | 0.3% | 31 | 24 | 61 | 11 | 82% |
| 23a | | | | | | | | |
| Scr001- | D + E | CHA + 3- | 0.15% + 0.15% | 31 | 24 | 61 | 19 | 70% |
| 23b | | CPP | | | | | | |
| Scr001- | K | Lavander | 0.3% | 31 | 14 | 69 | 34 | 50% |
| 24 | | stoechas | | | | | | |
| Scr001- | L | lavender | 100% | 5 × 10⁵ | 10 | 73 | 31 | 57% |
| 25 | | water | | | | | | |
| Scr001- | M | limonene | 0.3% | 31 | 12 | 49 | 58 | −19% |
| 26 | | | | | | | | |
| Scr001- | N | alpha | 0.3% | 31 | 26 | 61 | 32 | 48% |
| 27 | | terpineol | | | | | | |
| Scr001- | O | pinene | 0.3% | 31 | 20 | 33 | 23 | 30% |
| 28 | | | | | | | | |
| Scr001- | P | eucalyptol | 0.3% | 31 | 16 | 38 | 43 | −14% |
| 29 | | | | | | | | |
| Scr001- | N + O | alpha | 0.3% | 31 | 12 | 51 | 48 | 6% |
| 30 | | terpineol + | | | | | | |
| | | pinene | | | | | | |
| Scr001- | D + F | 3-CPP + 3- | 0.3% | 31 | 20 | 52 | 3 | 93% |
| 31 | | CHP | | | | | | |
| Scr001- | E + F | CHA + 3-CHP | 0.3% | 31 | 20 | 37 | 2 | 96% |
| 32 | | | | | | | | |
| Scr001- | E + F + N | CHA + 3- | 0.1% + 0.1% + 0.1% | 31 | 20 | 48 | 3 | 94% |
| 33 | | CHP + α | | | | | | |
| | | terpineol | | | | | | |
| Scr001- | D + F + N | 3-CPP + 3- | 0.1% + 0.1% + 0.1% | 31 | 20 | 57 | 3 | 95% |
| 34 | | CHP + α- | | | | | | |
| | | terpineol | | | | | | |
| Scr001- | A | WRA | 0.3% | 31 | 20 | 40 | 1 | 96% |
| 36 | | | | | | | | |
| Scr001- | D + F | 3-CPP + 3- | 0.1% + 0.1% | 21 | 20 | 47 | 3 | 94% |
| 37 | | CHP | | | | | | |
| Scr001- | E + F | CHA + 3-CHP | 0.1% + 0.1% | 21 | 20 | 25 | 4 | 85% |
| 38 | | | | | | | | |
| Scr001- | E + F | CHA + 3-CHP | 0.1% + 0.1% | 21 | 20 | 49 | 10 | 80% |
| 39 | | | | | | | | |
| Scr001- | A | WRA | 0.20% | 21 | 20 | 41 | 19 | 54% |
| 40 | | | | | | | | |
| Scr001- | Q | catnip | 0.20% | 31 | 20 | 44 | 19 | 56% |
| 41 | | | | | | | | |
| Scr001- | D + F + N | 3-CPP + 3- | 0.20% | 21 | 20 | 54 | 12 | 77% |
| 42 | | CHP + α- | | | | | | |
| | | terpineol | | | | | | |
| Scr001- | D + E + F | 3- | 0.1% + 0.1% + 0.1% | 31 | 20 | 46 | 5 | 89% |
| 43 | | CPP + CHA + | | | | | | |
| | | 3-CHP | | | | | | |

The abbreviations in Table 2 are the following:

WRA in Table 2 stands for a composition comprising 40% cyclohexyl acetic acid, 20% cyclopentyl propanoic acid and 40% cyclohexyl propanoic acid; CPP in Table 2 stands for cyclopentyl propanoic acid; CHP in Table 2 stands for cyclohexyl propanoic acid; CHA in Table 2 stands for cyclohexyl acetic acid; 3-CPP in Table 2 stands for 3-cyclopentyl propionic acid; and 3-CHP in Table 2 stands for 3-cyclohexyl propionic acid.

The score of the efficacy of the active principle was calculated with the following formula:

$$\% efficacy = \frac{\begin{matrix}\% engorement of control - \\ \% engorgement of the treated animal\end{matrix}}{\% engorgement of control}$$

where T is the average engorgement of the control animal and V is the average engorgement of the treated animal.

### Example 4

### Additional Testing in Guinea Pigs

The same procedure was followed in Example 3 with the following exceptions,

The mosquitoes utilized in this example were Aedes aegypti (Diptera Culicidae; Say 1823) strain ROCK. These mosquitoes were female having a post-age emergence between 4 and 12 days. They have never before had a blood meal.

The testing was effectuated in a closed room at a temperature of 27° C.±2° C. and a relative humidity of 70% (±10%). The tests were performed one hour before an artificial dawn. The period of photophase was 15 hours and the scotophase was 9 hours before twilight. The artificial dawn lasted one hour.

The mosquitoes had at their disposition a container with a cotton that was soaked in tap water.

The guinea pigs used in this example were male and female (Cavia porcellus). To be included in the study: (1) the guinea pigs did not present any hygienic problems; (2) the guinea pigs did not ever receive an insecticidal treatment; (3) the guinea pigs did not receive a treatment, as described herein, in the tested area for 1 week; (4) the guinea pigs were not anesthetized less than 3 days in advance; and (5) the guinea pigs weighed at least 500 g.

The guinea pigs were anesthetized with a mixture of ketamine¹⁰⁰⁰ and domitor®. 0.1 ml of ketamine¹⁰⁰⁰ and 0.1 ml domitor® were injected into their thigh. An ocular solution of Ocryl® gel was applied to the eyes of the guinea pigs to protect the cornea.

The treatment that was used was a mixture of 3-cyclopentyl propanoic acid and 3-cyclohexyl propanoic acid in equal parts (50 wt %/50 wt %) and an excipient; 3-cyclohexyl 2-methyl propanoic acid and 3-cyclopentyl 2-methyl propanoic acid in equal parts (50 wt %/50 wt %) and an excipient; and 3-cyclopentyl propanoic acid and 3-cyclohexyl 2-methyl propanoic acid in equal parts (50 wt %/50 wt %) and an excipient. The excipient was Tween®, glycerine and water. The treatment was applied at a dose of 0.5 ml on a surface of 48 cm².

0.030 g of 3-cyclopentyl propanoic acid, 0.030 g of 3-cyclohexyl propanoic acid, 14.015 g of deionized and sterilized water, 3.015 g of Tween® 80 and 2.410 g of glycerine were weighed and placed in a 100 ml beaker. The mixture was homogenized with an ultra turrax homogenizer at speed 3.

0.030 g of 3-cyclohexyl 2-methyl propanoic acid, 0.030 g of 3-cyclopentyl 2-methyl propanoic acid, 14.015 g of deionized and sterilized water, 3.015 g of Tween® 80 and 2.410 g of glycerine were weighed and placed in a 100 ml beaker. The mixture was homogenized with an ultra turrax homogenizer at speed 3.

0.030 g of 3-cyclopentyl propanoic acid, 0.030 g of 3-cyclohexyl 2-methyl propanoic acid, 14.015 g of deionized and sterilized water, 3.015 g of Tween® 80 and 2.410 g of glycerine were weighed and placed in a 100 ml beaker. The mixture was homogenized with an ultra turrax homogenizer at speed 3.

As a control for all three treatments above 14.615 g of deionized and sterilized water, 3.010 g of Tween® 80 and 2.405 g of glycerine were weighed and placed in a 100 ml beaker. The mixture was homogenized with an ultra turrax homogenizer at speed 3.

The maximum dose that was tested was 313 μg/cm² and the minimal dose tested was 31 μg/cm². The first dose that was tested was 160 μg/cm². The day before the test the syringes were prepared and filled with the appropriate solutions. Prior to filling the syringes the flasks were shaken to homogenize the solutions. 1 syringe contained the placebo as a control and the other 3 syringes contained various concentrations of the treatment. The syringes were clearly identified.

Prior to applying the solutions the technician dons vinyl gloves and proceeds to treat the guinea pig by depositing 0.1 ml of treatment or control (placebo) in the center of the shaved area and spreads the treatment on the surface in the form of a spiral (see 1 below). With the remaining 0.4 ml the technician placed it on the guinea pig and streaks the solutions 2 times in the manner shown in 2, 3 and 4 below:

The mosquitoes were released in the cages the same way as in Example 3. The experiment was conducted with 50 mosquitoes for each cage. The guinea pigs were exposed to the mosquitoes for a period of 30 minutes.

When the 30 minute contact between the mosquitoes and guinea pigs was finished, the mosquitoes in each of the cages were aspirated with the aid of an entomologic vacuum pump. The vacuum and the mosquitoes were placed in a plastic sack which was identified by the number of the cage. The four sacks were placed in a freezer for 15 minutes to kill the mosquitoes.

At the end of each test, the nets around the cages were taken down and washed in a washing machine with a reduced dose of cleaning liquid.

After the test the guinea pigs were washed. The zone that was treated was dampened, washed with soap without any odor and rinsed and once again washed with soap, rinsed and finally dried with absorbent paper.

After being washed, the guinea pigs were woken by an injection of 0.05 ml antisedan (atipamezole) and were placed on heated mats until they awoke.

To analyze the mosquitoes a piece of adhesive tape having a length of 12 cm and a width of 5 cm was cut. This adhesive tape was exposed sticky side up. Each group of mosquitoes was fixed to the adhesive ribbon. To facilitate their observation the mosquitoes were fixed in columns of 10 with 5 mosquitoes each. A piece of absorbent paper was placed on the tacky surface of the adhesive tape enclosing the mosquitoes between the adhesive tape and the absorbent paper.

The adhesive tape and the absorbent paper having the dead mosquitoes affixed thereto was then placed under a binocular microscope where the presence of blood was observed by backlight on the abdomen of the mosquitoes. The category of feeding was categorized in the following three classes:

0 feeding; no blood was observed in the abdomen;

Partial feeding was observed if less than ¼ of the abdomen was filled;

Total feeding of more than ¼ of the abdomen was filled.

The presence of blood was confirmed by crushing the abdomen by sliding the end of a clamp to the apex of the abdomen.

For each test the amount of protection was calculated based on the formula:

T=(G/G+NG)×100
where T=the average engorgement of the control guinea pig
G=number of mosquitoes bites on the control guinea pig
NG=number of mosquitoes that did not bite the control guinea pig
   and

V=(G₁/G₁+NG₁)×100
where V=the average engorgement of the treated guinea pigs
G₁=the number of mosquito bites on the 3 treated guinea pigs
NG₁=number of mosquitoes that did not bite the 3 treated guinea pigs

The formula of the percentage of diminution of bites with respect to the control was calculated as follows:

$$\% efficacy = ( 1 - \frac{V}{T} ) \times 100$$

Where V=the average engorgement of the treated guinea pigs
T=the average engorgement of the control guinea pig

If the dose tested had 95% protection the test was not repeated. If the dose tested was inferior to 95% or 100% the test was repeated. If a dose is superior to 95% an inferior dose was tested.

The following results were obtained for the semiochemical treatment of 3-cyclopentyl propanoic acid and 3-cyclohexylpropanoic acid for Aedes aegypti and are set forth in Table 3.

TABLE 3

| | dose | | | |
|---|---|---|---|---|
| concentration | μg/cm² | control | treated | % efficiency |
| 0.3% | 31 | 77.9% | 49.2% | 36.8% |
| 1.5% | 156 | 88.0% | 50% | 43% |
| 2.25% | 234 | 93.5% | 8.2% | 91% |
| 3% | 313 | 85.4% | 4.7% | 94% |

To confirm the effective dose at 85% during a period of 30 minutes with Aedes aegypti tested on the guinea pigs further analysis was undertaken. A descriptive analysis of the engorgement in the course of the testing appears in the Table 4 below for the semiochemical treatment of 3-cyclopentyl propanoic acid and 3-cyclohexyl propanoic acid at a test dose of 313 μg/cm² for Aedes aegypti:

TABLE 4

| | Number of | Number of | |
|---|---|---|---|
| Number | mosquito bites | mosquito bites | % |
| of test | Control group | Treated group | efficiency |
| 1 | 81% | 9% | 89% |
| 2 | 78% | 12% | 84% |
| 3 | 85% | 0.6% | 99% |
| 4 | 79% | 15.9% | 80% |
| 5 | 88% | 7.2% | 92% |
| Average | 82% | 9% | 89.1% |
| Standard | 4% | 6% | 7.3% |
| deviation | | | |

When the combination of 3-cyclohexyl 2-methyl propanoic acid and 3-cyclopentyl 2-methyl propanoic acid, in the excipient described above, was applied on the guinea pigs an efficient repulsive action against Aedes aegypti in a period of 30 minutes was achieved. The test dose was 310 μg/cm². There was 92% engorgement of the control, 24% of engorgement of the treated guinea pigs and an efficiency of 74% was achieved. The individual efficiencies for each guinea pig were 63%, 77% and 81%.

At a dose of 310 μg/cm² the combination of 3-cyclopentyl propanoic acid and 3-cyclohexyl 2-methyl propanoic acid in the excipient described above, was applied to guinea pigs an efficiency of 85% against Aedes aegypti for 30 minutes was achieved. The results are shown in the Table 5 below:

TABLE 5

| Control Group | Treated Group | % efficiency |
|---|---|---|
| 94% | 15% | 84% |

For each guinea pig the efficiencies were 76%, 87% and 90%.

Other tests were performed on guinea pigs and cats using combinations of D, which is 3-cyclopentyl propanoic acid, F, which is 3-cyclohexyl propanoic acid, X, which is 3-cyclohexyl 2-methyl propanoic acid and W, which is 3-cyclopentyl 2-methyl propanoic acid. The following Table 6 shows the results:

TABLE 6

| | | | | | Number | | | |
|---|---|---|---|---|---|---|---|---|
| | | | Number | Number | of bites | | | |
| | | Dose | of | of bites | of the | | | |
| Product | Concentration | tested | animals | of the | solution | % | | |
| tested | of solutions % | (μg/cm²) | tested | control | used | efficacy | host | mosquito |
| D + X | 0.15% + | 31 | 20 | 47% | 2% | 97% | guinea | Culex pipiens |
| | 0.15% | | | | | | pig | quinquefasciatus |
| D + F | 0.1% + 0.1% | 21 | 20 | 47% | 3% | 94% | guinea | Culex pipiens |
| | | | | | | | pig | quinquefasciatus |
| D + F | 0.15% + 0.15% | 31 | 20 | 52% | 3% | 93% | guinea | Culex pipiens |
| | | | | | | | pig | quinquefasciatus |
| D + F | 1.5% + 1.5% | 314 | 16 | 49.44% | 0.47% | 99% | cat | Aedes |
| D | 3.0% | 314 | 16 | 39% | 0% | 100% | cat | Culex pipiens |
| | | | | | | | | quinquefasciatus |

### Example 5

### Experimental Testing of the Efficacy of the Methylated 3-Cyclopentyl Propanoic Acid, Methylated Cyclohexyl Acetic Acid and Methylated 3-Cyclohexyl Propanoic Acid

The procedure that was followed was that in Example 3 using guinea pigs. The mosquitoes that were used in this experiment were Culex pipiens quinquefasciatus. The results are shown in Table 7 below.

TABLE 7

| | dose | % | number of | % bites for |
|---|---|---|---|---|
| | μg/cm² | efficacy | pairs tested | control |
| methylated | 31 | 77 | 10 | 44 |
| CHA | | | | |
| methylated | 31 | 89 | 20 | 22 |
| 3-CPP | | | | |
| methylated | 31 | 67 | 20 | 19 |
| 3-CHP | | | | |

In the above Table 7, CHA is cyclohexyl acetic acid, 3-CPP is 3-cyclopentyl propanoic acid and 3-CHP is 3-cyclohexyl propanoic acid. These results show that the methylated counterparts for cyclohexyl acetic acid, 3-cyclopentyl propanoic acid and is 3-cyclohexyl propanoic acid are also efficient in repelling mosquitoes.

### Example 6

### Experimental Testing of the Efficacy of Mixtures of 3-Cyclopentyl Propanoic Acid, Cyclohexyl Acetic Acid and 3-Cyclohexyl Propanoic Acid

Mixtures of 50% 3-cyclohexyl propanoic acid and 50% cyclohexyl acetic acid (w %/w %), mixtures of 50% 3-cyclopentyl propanoic acid and 50% cyclohexyl acetic acid (w %/w %) and mixtures of 50% 3-cyclopentyl propanoic acid and 50% 3-cyclohexyl propanoic acid (w %/w %) and mixtures of 50% 3-cyclopentyl propanoic acid and 50% methylated 3-cyclohexyl propanoic acid (w %/w %) were prepared.

The same experiment was conducted in the same manner as in Example 4 using guinea pigs, chickens and cats. The mosquitoes used in this experiment were Culex sp, Aedes sp and Anopheles. The results are set forth in Table 8 below.

TABLE 8

| | | | number | % bites | | |
|---|---|---|---|---|---|---|
| | dose | % | of pairs | for | mosquito | host |
| Mixture | μg/cm² | Efficacy | tested | control | tested | utilized |
| 3-CPP + | 31 | 93 | 10 | 52 | Culex sp | guinea |
| 3-CHP | | | | | | pig |
| 3-CHP + | 31 | 96 | 10 | 37 | Culex sp | guinea |
| CHA | | | | | | pig |
| 3-CPP + | 31 | 70 | 12 | 61 | Culex sp | guinea |
| CHA | | | | | | pig |
| 3-CPP + | 21 | 94 | 10 | 47 | Culex sp | guinea |
| 3-CHP | | | | | | pig |
| 3-CHP + | 21 | 80 | 10 | 49 | Culex sp | guinea |
| CHA | | | | | | pig |
| 3-CHP + | 31 | 69 | 10 | 79 | Culex sp | chicken |
| methylated | | | | | | |
| 3-CHP | | | | | | |
| 3-CPP + 3- | 31 | 73 | 6 | 81 | Anopheles | guinea |
| CHP | | | | | | pig |
| 3-CPP + | 314 | 99 | 8 | 49 | Culex sp | cat |
| 3-CHP | | | | | | |

### Example 7

### Experimental Testing of the Efficacy in Cats

The procedure that was followed was that in Example 4, except that cats (Felis domesticus) were tested instead of guinea pigs. The mosquitoes that were used in this experiement were Culex pipiens quinquefasciatus and Aedes aegypti. The results are set forth in Table 9 below.

TABLE 9

| | | | species of | |
|---|---|---|---|---|
| Product | Dose in | host | mosquitoes | % |
| tested | μg/cm² | utilized | tested | efficacy |
| 3-CPP | 32 | cat | Culex pipiens | 94% |
| | | | quinquefasciatus | |
| 3-CPP | 32 | cat | Culex pipiens | 100% |
| | | | quinquefasciatus | |
| 3-CPP | 324 | cat | Culex pipiens | 100% |
| | | | quinquefasciatus | |
| 3-CPP + | 313 | cat | Aedes aegypti | 99% |
| 3-CHP | | | | |

In the above Table 9 3-CPP is 3cyclopentyl propanoic acid and 3-CHP is 3-cyclohexyl propanoic acid.

These results show that 3-CPP and the combination of 3-CPP and 3-CHP are excellent deterrents of mosquitoes for cats.

### Example 8

### Experimental Testing of the Efficacy in Chickens

The objective of this assay was to evaluate the effect of a repulsive solution versus placebo with the aid of the engorgement of mosquitoes on poultry under laboratory conditions that are closely controlled and following an experimental plan in parallel groups. One group received the treatment and the other group received the placebo. The assay was not randomized; 4 chickens were included in the study per day of testing; 2 chickens received the treatment with the solution X, containing the semiochemical composition of 50% 3-cyclopentyl propionic acid and 50% 3-cyclohexyl 2-methyl propionic acid in a solution of 97% distilled water, 1.50% Tween® and 1.20% glycerine and 2 chickens received the product Y a control containing a solution of 97% distilled water, 1.50% Tween® and 1.20% glycerol. The assay was a semi-blinded assay.

In this example the influence of the mixture of 3-cyclopentyl propanoic acid and 3-cyclohexyl 2-methyl propanoic acid was tested on the mosquito bites of Culex pipiens quinquefasciatus on chickens (Gallus gallus domesticus).

A herd of male and female chickens (species Gallus gallus domesticus and from the stock Kabir) with an age of 8 weeks were used. To include the chickens in this study the following criteria were maintained: (1) The chickens did not have a health problems; (2) The chickens did not receive any insecticidal treatment; (3) The chickens did not receive any treatment in the zone in which they were tested for less than one week; and (4) The chickens were not anesthetized for less than 3 days before treatment.

The criteria for non-inclusion were (1) The chickens had a weight of less than 500 grams; or (2) The chickens had a weight superior to 3,000 grams.

The mosquitoes that were used in the test were Culex pipiens quinquefasciatus (Diptera: Culcidae; Say 1823) and were females having a post-emergence age between 4 and 21 days. They never had before a blood meal.

A “motivation” test was performed on the mosquitoes prior to engorging the chickens in order to determine if the mosquitoes were ready to bite. The following test was conducted in each of the cages to be used in the future experiment. A technician introduced one of his/her hands in an experimental cage and the cage was closed with elastic enclosing the wrist of the technician and the hand was exposed palm down. The technician removed his/her hand when three mosquitoes posed on it or after a period of 30 seconds. When at least 3 mosquitoes landed on the hand of the technician in 30 seconds, the mosquitoes were deemed ready to bite and the test of motivation is concluded for the cage.

The “motivation” test was repeated after one minute if the above conditions were not met after the previous failure. If the test of motivation failed after 5 consecutive trials the test was stopped for the day.

The tests were effectuated in a closed room having a temperature of 27° C.±2° C. and having a relative humidity of 70%±10%. The tests were conducted in complete darkness in the laboratory having artificial night. The period of photophase was 15 hours and scotophase was 9 hours with a twilight and artificial dawn of 1 hour.

Four (4) chickens were tested, thus 2 couples one receiving the treatment X while the other receiving a placebo Y as a control. The cages used in the test were composed of a plastic structure having the dimensions 29×29×29 cm. A rigid plastic plate was fixed on the upper side of the cage. A sheer mosquito net was slipped over the plastic structure and the ends of the mosquito net were secured with rubber bands (See, FIG. 3). In each cage the mosquitoes had access to a container containing a piece of cotton soaked with tap water.

The mosquitoes were transferred to their net below the cages for the chickens by an entomological vacuum pump. The number of mosquitoes obtained by the suction was counted by aid of a mechanical counter. The sex was determined by observation of their antennas. 50 female mosquitoes were provided to each net.

Since it was necessary that the mosquitoes have access to the treated zone in which they can bite the zones that were considered as non-treated zones were protected by an installation template. The installation template was constructed using a flexible piece of plastic that had the dimensions of 21×29 cm and a thickness of 4 mm in which was cut a rectangle of 7 cm by 5 cm. It is a physical barrier to any mosquito bites. This template permitted the mosquitoes to bite only in the zone of the chicken that was treated or was administered a placebo as a control. At the end of each test the template was washed and reused.

The treatments were then prepared in the following manner. Solution X, the treatment, was prepared by weighing 0.075 g of 3-cyclopentyl propionic acid, 0.075 g of 3-cyclohexyl 2-methyl propionic acid, 44.610 g of deionized and sterilized water, 0.695 g of Tween®80 and 0.565 g of glycerine in a 100 ml beaker. An ultra turrax homogenizer was used to mix the chemicals using a speed of 2.

Solution Y, the control, was prepared by weighing 44.720 g of deionized and sterilized water, 0.690 g of Tween® 80 and 0.570 g of glycerine in a 100 ml beaker. An ultra turrax homogenizer was used to mix the chemicals using a speed of 2.

Both treatments were kept in flasks and maintained at ambient temperature and protected from light. The test was conducted semi-blind, but the application was not blind, but the technician did not know the nature of the solutions tested. For this reason the solutions were labeled X and Y.

Each test was performed in 2 days. On the first day the experimental cages and the area in which the mosquitoes could bite through a screen were prepared.

The next day, the chickens were anesthetized with a mixture of ketamine¹⁰⁰⁰ (100 mg/ml) and Domitor®(1 mg/ml) which was injected in the thigh muscle. A dose of 0.15 ml of ketamine¹⁰⁰⁰ and 0.15 ml of Domitor® per kilogram of chicken weight were administered to each chicken. A solution of Ocryl® gel was applied on the eyes of the chickens.

The feathers on the chickens were plucked in the zone tested for the mosquito bites. Once the chickens were anesthetized their back was plucked on a rectangular surface measuring 8×6 cm. The length of this zone (8 cm) is between the scapula (under the wings) and the base of the rump (pelvis). The width of 6 cm was centered on the vertebral column of the animal.

The uprooting of the feathers did not permit to delimit with precision a precise zone of 8×6 cm. Also to delimit the contours of the area to be treated a plastic template (8×6 cm) whose contours were traced with a permanent marker was utilized. This zone was called the zone of treatment.

The chickens were placed on top of their respective cages and positioned such that the zone of treatment was centered on the open work of the plastic template. This zone was the only zone to which the mosquitoes had access. A stopwatch was started when the chickens were established.

Each day of testing 4 syringes having a capacity of 1 ml were prepared containing 0.5 ml of the treatment or placebo as a control. Before inserting into the syringes the flasks were turned over 5 times to homogenize the solutions. Each syringe was filled by aspirating the solution contained in the corresponding flask. Two syringes contained the solution X and two syringes contained the solution Y and were identified as such.

Application of the solutions was performed by a technician. Donning vinyl gloves the technician took the syringe containing the treatment assigned to the chicken and applied 0.1 ml of treatment to the center of the treatment zone. The treatment was then spread over the entire surface. The remaining treatment of 0.4 ml was applied to the median line dividing the width area. The solution was then spread over the larger zone with a finger. The technician changed gloves each time a new treatment was applied.

The dose of the treatment was 31 μg/cm². The surface application was 48 cm². The quantity of treatment that was applied was 0.5 ml.

When the 30 minute contact between the mosquitoes and chickens was finished, the mosquitoes in each of the cages were aspirated with the aid of an entomologic vacuum pump. The vacuum and the mosquitoes were placed in a plastic sack which was identified by the number of the cage. The four sacks were placed in a freezer for 15 minutes to kill the mosquitoes.

At the end of each test, the nets around the cages were taken down and washed in a washing machine with a reduced dose of cleaning liquid.

After the test the chickens were washed. The zone that was treated was dampened and washed with soap without any odor and rinsed and once again washed with soap, rinsed and finally dried with absorbent paper.

After being washed, the chickens were woken by an injection of 0.08 ml antisedan (atipamezole) per kilogram of chicken weight.

To analyze the mosquitoes a piece of adhesive tape having a length of 12 cm and a width of 5 cm was cut. This adhesive tape was exposed sticky side up. Each group of mosquitoes was fixed to the adhesive tape. To facilitate their observation the mosquitoes were fixed in a column of 10 with 5 mosquitoes each. A piece of absorbent paper was placed on the tacky surface of the adhesive tape enclosing the mosquitoes between the adhesive tape and the absorbent paper.

The adhesive tape and the absorbent paper having the dead mosquitoes affixed thereto was then placed under a binocular microscope where the presence of blood was observed by backlight on the abdomen of the mosquitoes. The category of feeding was categorized in the following three classes:

0 feeding; no blood was observed in the abdomen;

Partial feeding was observed if less than ¼ of the abdomen was filled;

Total feeding of more than ¼ of the abdomen was filled.

The presence of blood was confirmed by crushing the abdomen by sliding the end of a clamp to the apex of the abdomen.

The test was repeated 5 times, but the number could increase if the results were not satisfactory. After 5 repetitions, of the test the collection of data was achieved and the data was blindly analyzed. A difference was achieved between the treated chickens and the control chickens via the analysis of the mosquitoes that bit the chickens.

For each replication if the individual chicken bitten in the control group was inferior to 20% (average 2 control chickens by replication), the replication was excluded from the analysis and a new replication was performed. In effect this reflects an experimental bias such as the livestock or lighting where the validity of the results would then be called into question.

Descriptive Analysis

The raw data is presented in the Table 10 below for the 20 chickens tested.

TABLE 10

| | | | Mosquito | Mosquito | Mosquito |
|---|---|---|---|---|---|
| | | | Bites- | Bites- | Bites- |
| Number | Cage | Treatment | No | Partial | Total |
| of trials | Number | & Control* | feeding | feeding | feeding |
| 1 | 1 | X | 21 | 0 | 27 |
| 1 | 2 | Y | 2 | 0 | 47 |
| 1 | 3 | X | 39 | 0 | 11 |
| 1 | 4 | Y | 10 | 0 | 41 |
| 2 | 1 | X | 47 | 0 | 6 |
| 2 | 2 | Y | 8 | 0 | 44 |
| 2 | 3 | X | 42 | 0 | 8 |
| 2 | 4 | Y | 6 | 0 | 47 |
| 3 | 1 | X | 51 | 0 | 0 |
| 3 | 2 | Y | 11 | 0 | 41 |
| 3 | 3 | X | 51 | 0 | 1 |
| 3 | 4 | Y | 23 | 0 | 30 |
| 4 | 1 | X | 24 | 1 | 27 |
| 4 | 2 | Y | 5 | 0 | 43 |
| 4 | 3 | X | 33 | 0 | 19 |
| 4 | 4 | Y | 18 | 1 | 29 |
| 5 | 1 | X | 42 | 0 | 9 |
| 5 | 2 | Y | 20 | 0 | 36 |
| 5 | 3 | X | 34 | 0 | 18 |
| 5 | 4 | Y | 2 | 0 | 47 |

*where X is the treatment and Y is the control

Descriptive Analysis

A descriptive analysis was then undertaken and the results are shown in Table 11 below.

TABLE 11

| | Treatment X | | | Treatment Y | | |
|---|---|---|---|---|---|---|
| | No | Partial | Total | No | Partial | Total |
| | engorgement | engorgement | engorgement | engorgement | engorgement | engorgement |
| Sum | 384 | 1 | 126 | 105 | 1 | 405 |
| Average | 38 | 0 | 13 | 11 | 0 | 41 |
| Standard | 10 | 0 | 10 | 7 | 0 | 7 |
| deviation | | | | | | |
| Number of | 511 | 511 | 511 | 511 | 511 | 511 |
| mosquitoes | | | | | | |
| tested | | | | | | |
| Number of | 127 | 127 | 127 | 406 | 406 | 406 |
| mosquitoes | | | | | | |
| engorged | | | | | | |
| percent | 25% | 25% | 25% | 79% | 79% | 79% |
| engorgement | | | | | | |

The total number of mosquitoes tested was 1,022.

Box Plot Analysis

A box plot analysis was undertaken and the results are shown in Table 12 below.

TABLE 12

| Categories | Treatment X | Treatment Y |
|---|---|---|
| 1^{st} quartile | 12% | 68% |
| Minimum data | 0% | 57% |
| Inferior whisker | 0% | 57% |
| Median | 20% | 83% |
| Average | 25% | 80% |
| Superior whisker | 56% | 96% |
| Maximum | 56% | 96% |
| 3er quartile | 36% | 89% |
| Atypical inferior number | — | — |
| atypical superior | — | — |
| number | | |
| effective | 10 | 10 |

where X is the treatment and Y is the control

No value is considered atypical. The number of engorged chicken ranged from 0% to 56% for treatment X and from 57% to 96% for the control Y. The average engorgement was 25% for treatment X and 80% for the control Y.

Statistical Analysis

Further statistical analysis was carried out and analyzed using the software Statistica* version 10.0. Univariate tests of significance were performed and shown in the Table 13 below.

TABLE 13

| | | | | Degree of | |
|---|---|---|---|---|---|
| | Sum of | Degree | Mean | freedom | |
| effect | squares | of liberty | square | F | p value |
| Ordinate of | 5,4861.07 | 1 | 5,486.07 | 256.8060 | 0.000000 |
| origin | | | | | |
| Number of | 2,101.84 | 4 | 525.46 | 2.4597 | 0.113231 |
| replications | | | | | |
| Treatment | 1,497.48 | 1 | 1,497.48 | 70.0819 | 0.000008 |
| Number of | 1,081.47 | 4 | 270.37 | 1.2656 | 0.345735 |
| replications | | | | | |
| x treatment | | | | | |
| error | 2,136.28 | 10 | 213.63 | | |

where X is the treatment and Y is the control

There was not any significant difference between the different testing days (p=0.113231). A significant difference was observed between the treatment X and control Y (p=000008). The interaction is not significant (p=0.345735).

The student T-test was then undertaken for the independent examples. The Results are shown in Table 14 below.

TABLE 14
Student T test. The variable is the assessment
of engorged mosquitoes

| | |
|---|---|
| Average treatment with X | 25.01409 |
| Average treatment with Y | 79.73425 |
| T value | −7.11753 |
| dl | 18 |
| P | 0.000001 |
| Number of active treatments with X | 10 |
| Number of active treatments with Y | 10 |
| Standard deviation with treatment X | 19.78491 |
| Standard deviation with treatment Y | 14.12882 |
| Ratio of F variance | 1.960905 |
| P variance | 0.330204 |

where X is the treatment and Y is the control

A significant difference is observed between the products X and Y in favor of X. The variances are homogeneous.

The Mann Whitney test was then performed. The results are shown in Table 15 below:

### Mann Whitney U Test

TABLE 15

| | |
|---|---|
| Rank sum X | 55 |
| Rank sum Y | 155 |
| U | 0 |
| Z | −3.74185 |
| p value | 0.000183 |
| Adjusted z | −3.74326 |
| p value | 0.000182 |
| Number of active X | 10 |
| Number of active Y | 10 |
| P exact = 2*(1-p) | 0.000011 |

where X is the treatment and Y is the control

A significant difference exists between X and Y in favor of product X.

Calculation of the Type II Error and Strength of the Test

The probability to accept the null hypothesis of the equality of engorgement is 0% (β). The strength of the test is 100% (1−β). The formula of efficiency is:

$$\% efficacy = ( 1 - \frac{V}{T} ) \times 100$$

where T=the average rate of engorgement for the control chickens;

V=the average rate of engorgement for the treated chickens.

Thus % efficiency=(1−25/79.7)×100=68.6%

The treatment at 31μg/cm² diminishes the number of mosquitoes needing a blood meal with an efficiency of 68.6% during 30 minutes for 0.3% 3-cyclopentyl propionic acid and 3-cyclohexyl 2-methyl propionic acid.

Concerning the percentage of mosquitoes biting the chickens at the end of the assay the following was observed. The percentage of mosquitoes that bit oscillates between 0 and 56.3 for the product X and the standard deviation is on the order of 19.8 for an average of 25. The percentage of mosquitoes that bit oscillates between 56.6 and 95.9 for the product Y and the standard deviation is on the order of 14.1 for an average of 79.3.

Solution X-50% 3-cyclopentyl propionic acid and 50% 3-cyclohexyl 2-methyl propionic acid in a solution of 97% distilled water, 1.50% Tween® and 1.20% glycerine resulted in descriptive statics that are set forth in Table 16 below:

TABLE 16

| | | | | | | | | Standard |
|---|---|---|---|---|---|---|---|---|
| | | | | | | | | deviation |
| | Number | | | | | 1er | 3eme | of rate of |
| variable | active | average | median | minimum | maximum | quartile | quartile | bites |
| Rate of | 10 | 25.01409 | 19.82353 | 0.00 | 56.2500 | 11.32076 | 36.53846 | 19.78491 |
| bites | | | | | | | | |

Solution Y-control-97% distilled water, 1.50% Tween® and 1.20% glycerol resulted in a descriptive analysis set forth in Table 17 below.

TABLE 17

| | | | | | | | | Standard |
|---|---|---|---|---|---|---|---|---|
| | | | | | | | | deviation |
| | Number | | | | | 1er | 3eme | of rate of |
| variable | active | average | median | minimum | maximum | quartile | quartile | bites |
| Rate of | 10 | 79.73425 | 82.50377 | 56.60377 | 95.91837 | 64.28571 | 89.58333 | 14.12882 |
| bites | | | | | | | | |

A test of the comparison of multiple posterior means via the HSD test of Tukey is set forth in the Table 18 below.

TABLE 18

| Cell | | 1 | 2 |
|---|---|---|---|
| number | treatment | 25.014 | 79.734 |
| 1 | X | | 0.000190 |
| 2 | Y | 0.000190 | |

where X is the control and Y is the treatment

The model of analysis of the variance was then calculated and the results are set forth in Table 19 below.

TABLE 19

| | | Degree of | | | |
|---|---|---|---|---|---|
| Effect | SC | freedom | MC | F | p value |
| Ord. origin | 5,4861.07 | 1 | 5,4861.07 | 256.8060 | 0.000000 |
| Number of | 2,101.84 | 4 | 525.46 | 2.4597 | 0.113231 |
| chickens | | | | | |
| Treatment | 1,497.48 | 1 | 1,4971.48 | 70.0819 | 0.000008 |
| Number of | 1,081.47 | 4 | 270.37 | 1.2656 | 0.345735 |
| chickens | | | | | |
| treated | | | | | |
| error | 2,136.28 | 10 | 213.63 | | |

There is no significant difference observed in the assay between different days (p=0.113231). A significant difference is observed between X and Y in favor of the product X (p=0.000008).

In conclusion the mosquito bites in the control group using solution Y was 79.45%. In the semiochemical composition solution group X the mosquito bites was 24.9% in the chickens. Hence an efficiency of 69% for 30 minutes at a dose of 31 pg/cm² using the semichemical composition of 50% 3-cyclopentyl propionic acid and 50% 3-cyclohexyl 2-methyl propionic acid in a solution of 97% distilled water, 1.50% to Tween® and 1.20% glycerol.

In summary the percentage efficiency is lower than 80% and the efficacy is good (+ than 95%) The effect of the product X is significant.

### Example 9

### Experimental Testing of the Efficacy in Horses

A. Testing of MOS-007

The semiochemical composition that was tested was 50% 3-cylclopentyl propionic acid and 50% 3-cyclohexyl propionic acid against Simuliidae sp (Diptera)

This example was performed in the afternoon for 3 days. 15 horses were tested.

The treated group containing the semiochemical composition contained the active semiochemical and an excipient. 1.531 g of 2-cyclopentyl propionic acid, 1.515 g of 3-cyclohexyl propionic acid, 90.5 g of deionized and sterilized water, 1.500 g of Benecel™ K200M and 5.0 g of glycerine was mixed using an ultra turrax homogenizer at a speed of 3. After the compounds were dispersed 0.875 g of KOH and 1.5 g of Millipore water were added to obtain a white gel having a viscosity comparable to the known product Equanimity®.

The control, without the active semiochemical, contained only the excipient. 0.595 g of Isopar V, 93.495 g of Millipore water, 1.525 g of Benecel™ K200M and 5.100 g of glycerol was mixed using an ultra turrax homogenizer at a speed of 5.

1 ml of the product of the semiochemical composition or 1 ml of the control having only the excipient in the form of a gel and water was applied to left ear of the horse. After 1 hour the ear was observed by two technicians and checked for black flies. A study T test was performed and the results are shown in the Table 20 below:

TABLE 20

| | Treated semiochemical | Control excipient only |
|---|---|---|
| | group | group |
| Total | 52 | 98 |
| Average | 4.33 | 8.16 |

There was no effect with the treatment since p=0.12. Therefore the amount of treatment was increased.

B. Testing of MOS-009

The treated group containing the semiochemical composition contained the active semiochemical and an excipient. 1.530 g of 2-cyclopentyl propionic acid, 1.510 g of 3-cyclohexyl propionic acid, 90.510 g of deionized and sterilized water, 1.500 g of Benecel™ K200M and 5.050 g of glycerine was weighed and mixed in a 200 ml beaker using an ultra turrax homogenizer at a speed of 3. After the compounds were dispersed 0.875 g of KOH and 1.5 g of deionized and sterilized water were added to obtain a white gel having a viscosity comparable to the known product Equanimity®.

The control, without the active semiochemical contained only excipient. 0.605 g sopar V, 90.510 g of deionized and sterilized water, 1.500 g of Benecel™ K200M and 5.050 g of glycerine was mixed in a 200 ml beaker using an ultra turrax homogenizer at a speed of 5.

The same test was performed with 5 ml of semiochemical compositions and control composition in the form of a gel and water. 8 horses were tested. The treatment was applied to the right or left inner ear of the horse, while the control was applied to the other inner ear. After 1 hour of waiting observers were requested to count the number of black flies that remained in each ear of the horse.

The number of black flies observed by both technicians was the same. A student T test was performed and the results are shown in the Table 21 below:

TABLE 21

| | Treated semiochemical | Control excipient group |
|---|---|---|
| | group | |
| Total | 7 | 46.5 |
| Average | 0.875 | 5.812 |
| Ears without black flies | 50% | 0% |

There was no effect with the treatment since p=0.054. 50% of the treated ears were without black flies, which was interesting data. The reason why was that less horses were tested and there were less black flies. 6 observed per horse instead of 12 in the above experiment with MOS007.

C. Testing of MOS-010

The test was performed in the morning on a large group of horses which resided in an area known to have black fly infestations. The area where the horses resided was by a river. It is well a known that black flies breed in water.

20 horses were initially used in this study, but 4 were eliminated since no black flies were observed in either ear of these horses.

Solution A, containing the semiochemical composition, was obtained by weighing in a 200 ml beaker 3.055 of 3-cyclopentyl propionic acid, 3.035 g of 3-cyclohexyl propionic acid, 181.065 g of deionized and sterilized water, 3.025 g of Benecel™ K200M and 10.045 g of glycerol and mixing using an ultra turrax homogenizer at a speed of 3. After the compounds were dispersed 1.75 g of KOH and 3.0 g of Millipore water were added to obtain a white gel having a viscosity comparable to the know product Equanimity®.

Solution B, the control, was obtained by weighing in a 200 ml beaker 2.005 g of isopar V, 183.020 g of deionized and sterilized water, 3.005 g of Benecel K200M and 10.040 g of glycerol. The chemicals were mixed with an Ultra turrex homogenizer at speed 5.

The time between the application of the treated group and the control group was 1 hour and 1½ hours. The number of black flies observed by both technicians was the same. The normality was unaudited. A T test of Wilcoxon was performed with the following results set forth in the Table 22 below.

TABLE 22

| | Treated group | Control group |
|---|---|---|
| Total | 12 | 121.5 |
| Average | 0.75 | 7.59 |
| Ears without blackflies | 56% | 0% |

There was a significant difference between the treated group and the control group and p=0.01. There was an average of 10 times more black flies in the control group. The data obtained was very interesting since after 1½ hours after the application 1 versus 33 black flies were in the treated group and 5 versus 42 black flies were in the control group.

Table 23 below shows the descriptive statistics for MOS-010:

TABLE 23

| | Number of | | | | | Standard |
|---|---|---|---|---|---|---|
| variable | actives | average | median | minimum | maximum | deviation |
| Product A | 16 | 0.750000 | 0.000000 | 0.000000 | 5.000000 | 1.37840 |
| Product B | 16 | 7.593750 | 1.250000 | 1.000000 | 42.000000 | 12.58070 |
| Left ear | 16 | 4.562500 | 1.000000 | 0.000000 | 33.000000 | 8.90108 |
| Right ear | 16 | 3.781250 | 1.000000 | 0.000000 | 42.000000 | 10.27614 |

Normality of counting variables was then analyzed.

The statistics of synthesis for the first observer for the left ear was as follows in Table 24:

TABLE 24

| | |
|---|---|
| Number of actives | 16.000000 |
| Average | 5.250000 |
| Median | 1.000000 |
| Minimum | 0.000000 |
| Maximum | 38.000000 |
| Standard deviation | 10.433919 |

The statistics of synthesis for the second observer for the left ear was as follows in Table 25:

TABLE 25

| | |
|---|---|
| Number of actives | 16.000000 |
| Average | 3.875000 |
| Median | 1.000000 |
| Minimum | 0.000000 |
| Maximum | 28.000000 |
| Standard deviation | 7.392564 |

The statistics of synthesis for the first observer for the right ear was as follows in Table 26:

TABLE 26

| | |
|---|---|
| Number of actives | 16.000000 |
| Average | 3.562500 |
| Median | 1.000000 |
| Minimum | 0.000000 |
| Maximum | 40.000000 |
| Standard deviation | 9.804548 |

The statistics of synthesis for the second observer for the right ear was as follows in Table 27 below:

TABLE 27

| | |
|---|---|
| Number of actives | 16.000000 |
| Average | 4.000000 |
| Median | 1.000000 |
| Minimum | 0.000000 |
| Maximum | 44.000000 |
| Standard deviation | 10.751744 |

Graphic correlation was then undertaken. A linear relationship existed between the two observers for the response variable studied. With respect to the reliability of the two observers, the calculation of the correlation matrix is set forth in Table 28 below:

TABLE 28

| variable | 2^{nd} observer left ear | 2^{nd} observer right ear |
|---|---|---|
| 1^{st} observer left ear | 0.994381* | −0.001189 |
| 1^{st} observer right ear | 0.046104 | 0.99216 * |

To verify the reliability of the two observers it is sufficient to observe the values in blue * in the above table of this correlation matrix to obtain the results for calculating the coefficient and the results corresponding to the test of the coefficient of correlation. Also these results were in fact in significant agreement because the coefficient of correlation was significantly different than 0 and is superior or equal to 0.9 (when 0.9<r<1 the correlation was very high and a strong link between the 2 variables (Measuring Behavior, Paul Martin and Patrick Bateson 2005). Also for further analysis of the data, the data of the two observers were averaged.

A test of Wilcoxon for the samples was then undertaken and the results are shown in Table 29 below:

TABLE 29

| Pairs of | Number of | | | |
|---|---|---|---|---|
| variables | actives | T | Z | p value |
| Product A & | 14 | 0.000000 | 3.295765 | 0.000982 |
| B | | | | |
| Left & right | 14 | 51.00000 | 0.094165 | 0.924978 |
| ear | | | | |

There is a significant difference between the two products in favor of product A. No significant difference existed between the left and right ears.

D. Data on MOS-009+MOS-010

The data was combined for MOS-009 and MOS-010 in which the total number of actives was 24; 8 horses for MOS-009 and 16 horses for MOS-010.

Table 30 below shows the descriptive statistics:

TABLE 30

| | Number of | | | | | Standard |
|---|---|---|---|---|---|---|
| variable | actives | average | median | minimum | maximum | deviation |
| Product A | 24 | 0.791667 | 0.000000 | 0.000000 | 5.000000 | 1.30148 |
| Product B | 24 | 7.000000 | 1.500000 | 1.000000 | 42.000000 | 10.78848 |
| Left ear | 24 | 4.187500 | 1.00000 | 0.000000 | 33.000000 | 7.89443 |
| Right ear | 24 | 3.604167 | 1.00000 | 0.000000 | 42.000000 | 8.70030 |

Where product A is the semiochemical and product B is the control.

Normality of counting variables was then analyzed.

The statistics of synthesis for the first observer for the left ear was as follows in Table 31:

TABLE 31

| | |
|---|---|
| Number of actives | 24.000000 |
| Average | 4.500000 |
| Median | 1.000000 |
| Minimum | 0.000000 |
| Maximum | 38.000000 |
| Standard deviation | 8.910180 |

The statistics of synthesis for the second observer for the left ear was as follows in Table 32:

TABLE 32

| | |
|---|---|
| Number of actives | 24.000000 |
| Average | 3.875000 |
| Median | 1.000000 |
| Minimum | 0.000000 |
| Maximum | 28.000000 |
| Standard deviation | 7.054524 |

The statistics of synthesis for the first observer for the right ear was as follows in Table 33:

TABLE 33

| | |
|---|---|
| Number of actives | 24.000000 |
| Average | 3.375000 |
| Median | 1.000000 |
| Minimum | 0.000000 |
| Maximum | 40.000000 |
| Standard deviation | 8.261027 |

The statistics of synthesis for the second observer for the right ear was as follows in Table 34:

TABLE 34

| | |
|---|---|
| Number of actives | 24.000000 |
| Average | 3.833333 |
| Median | 1.000000 |
| Minimum | 0.000000 |
| Maximum | 44.000000 |
| Standard deviation | 9.149325 |

Graphic correlation was then undertaken. A linear relationship existed between the two observers for the response variable studied. With respect to the reliability of the two observers, the calculation of the correlation matrix is set forth in Table 35 below:

TABLE 35

| variable | 2^{nd} observer left ear | 2^{nd} observer right ear |
|---|---|---|
| 1^{st} observer left ear | 0.955584* | −0.010667 |
| 1^{st} observer right ear | 0.012776 | 0.997754* |

To verify the reliability of the two observers it was sufficient to observe the values in blue* in the above table of this correlation matrix to obtain the results for calculating the coefficient and the results corresponding to the test of the coefficient of correlation. Also these results were in fact in significant agreement because the coefficient of correlation was significantly different than 0 and was superior or equal to 0.9 (when 0.9<r<1 the correlation was very high and a strong link between the 2 variables (Measuring Behavior, Paul Martin and Patrick Bateson 2005). Also for further analysis of the data, the data of the two observers were averaged.

Normality of the variable difference was then undertaken to determine the statistical difference between product A and product B where product A is the semiochemical and product B is the control.

The results are shown in Table 36 below.

TABLE 36

| | |
|---|---|
| Number of actives | 24.000000 |
| Average | −6.208333 |
| Median | −1.500000 |
| Minimum | −37.000000 |
| Maximum | 0.500000 |
| Standard deviation | 9.904892 |

Statistical difference between left ear and right ear was undertaken and the results are shown in Table 37 below.

TABLE 37

| | |
|---|---|
| Number of actives | 24.000000 |
| Average | 0.583333 |
| Median | 0.000000 |
| Minimum | −37.000000 |
| Maximum | 32.000000 |
| Standard deviation | 11.746106 |

A test of Wilcoxon for the samples was then undertaken and the results are shown in Table 38 below:

TABLE 38

| Pairs of | Number of | | | |
|---|---|---|---|---|
| variables | actives | T | Z | p value |
| Product A & B | 20 | 1.000000 | 3.882598 | 0.000103 |
| Left & right | 20 | 104.50000 | 0.018666 | 0.985107 |
| ear | | | | |

There was a significant difference between the two products in favor of product A, the semiochemical.

No significant difference existed between the left and right ears.

E. Testing of MOS-011

3 horses were tested in this example in a location where there was a river besides the horse pasture. Unlike other examples, after the ear of the horse was washed a horse-mask protecting the eyes and ears of the horse was placed over the horses head.

The treated group A containing the semiochemical composition contained the active semiochemical and an excipient. 1.530 g of 3-cyclopentyl propionic acid, 1.510 g of 3-cyclohexyl propionic acid, 90.510 g of Millipore water, 1.500 g of Benecel K200M and 5.050 g of glycerine was weighed and mixed in a 200 ml beaker using an ultra turrax homogenizer at a speed of 3. After dispersion 0.875 g of KOH and 1.5 g of Millipore water was added a white gel having a viscosity comparable to Equanimity® was obtained. As a control 0.605 g ispar V, 93.50 g of Millipore water 1.515 g of Benecel K200M and 5.025 g of glycerine was fabricated in the same manner as the semiochemical without the addition of 0.875 g of KOH and 1.5 g of Millipore water.

The horse was administered the product A (semiochemical) or product B (the control) which was administered as a gel in water. The time between the application of the product and the gel was 1½ hours, 3 hours, 5 hours and 7 hours.

The numbers counted by the two observers was equivalent. A t test of Wilcoxon was undertaken and the results are shown in Table 39 below:

TABLE 39

| | 1½ hours | 3 hours | 5 hours | 7 hours |
|---|---|---|---|---|
| Average for | 0 | 1.17 | 4 | 3.17 |
| treatment | | | | |
| Average for | 7.83 | 8.17 | 13.83 | 12.5 |
| control | | | | |
| p value | 11.45% | 6.04% | 29.29% | 14.02% |

The results showed favorably for the observation at 3 hours since p=0.06. There were more blackflies in the control that were extended with time.

F. Testing of MOS-013

3 horses were tested in this example in a location where there was a river besides the horse pasture. The ear of the horse was washed and a horse-mask protecting the eyes and ears of the horse was placed over the horses head between washing and the application of the treatment.

The treated group A containing the semiochemical composition contained the active semiochemical and an excipient. 1.525 g of 3-cyclopentyl propionic acid, 1.515 g of 3-cyclohexyl propionic acid and 97.020 g of Transcutol® P (2-(2-ethoxy)ethanol) were mixed. The control, without the active semiochemical contained only excipient of 100.020 g of Transcutol® P (2-(2-ethoxy)ethanol).

The time between the application of the product and the gel was 1½ hours, 3 hours, 5 hours and 7 hours.

The numbers counted by the two observers was not equivalent in 3 instances. The student t test results are set forth in Table 40 below:

TABLE 40

| | 1½ hours | 3 hours | 5 hours | 7 hours |
|---|---|---|---|---|
| Average | 0 | 0 | 0 | 0.17 |
| treatment | | | | |
| Average | 0 | 0 | 4 | 8.83 |
| control | | | | |
| p value | | | 0.109 | 0.108 |

The excipient provided protection of the horse for three hours. In absence of the excipient the black flies were present for 7 hours.

G. Testing of MOS-014

This was a pilot test with 6 horses in a region where there was a river close to the horse pasture. The time between the application of the product and the gel was 1½ hours, 3 hours, 4, hours 5 hours, 7 hours, 8 hours and 23 hours.

3 different excipients were tested, one containing the semiochemical composition and the other the control containing only the excipient which were the following:
30% transcutol+70% glycerine—composition A
50% transcutol+50% glycerine—composition B
70% transcutol+30% glycerine—composition C

The above composition A was formulated as follows. 1.5 g of 3-cyclopentyl priopionic acid, 1.5 g of 3-cyclohexyl propionic acid, 30.0 g of glycerine and QSP'd with 70.00 g of Transuctol® P. 3%(wt %) of the semiochemical composition was in this formulation. For the control 30.0 g of glycerine and QSP'd with 70.00 g of Transuctol® P was used.

The above composition B was formulated as follows. 1.5 g of 3-cyclopentyl propionic acid, 1.5 g of 3-cyclohexyl propionic acid, 50.0 g of glycerine and QSP'd with 50.00 g of Transuctol® P. 3% (wt %) of the semiochemical composition was in this formulation. For the control 50.0 g of glycerine and QSP'd with 50.00 g of Transuctol® P was used.

The above composition C was formulated as follows. 1.5 g of 3-cyclopentyl propionic acid, 1.5 g of 3-cyclohexyl propionic acid, 70.0 g of glycerine and QSP'd with 30.00 g of Transuctol® P. 3% (wt %) of the semiochemical composition was in this formulation. For the control 70.0 g of glycerine and QSP'd with 30.00 g of Transuctol® P was used.

The time between the application of the product and the gel was 1½ hours, 3 hours, 4, hours 5 hours, 7 hours, 8 hours and 23 hours. The number of counting of the observers was equivalent. A student t test was performed, however a comparison was impossible for the first four observations at 1½ hours and 5 hours for the excipients with 70% and 50% glycerine.

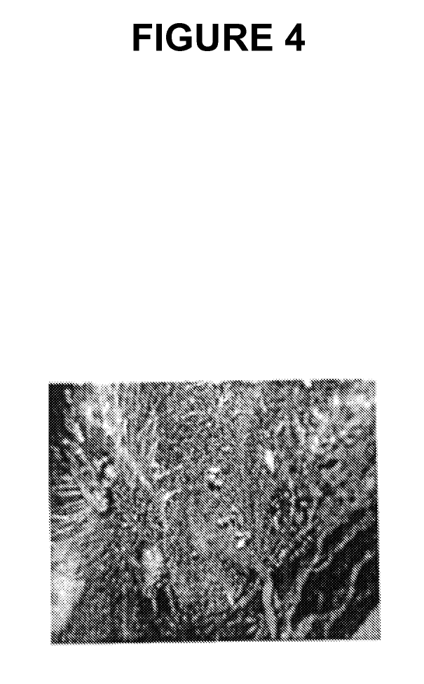

It was observed that the mixture of glycerine and Transcutol® P increased the protection of the active principle. The blackfly reinfested the control ear before the treated ear and in a very large number (see, FIG. 4). The results are shown in Tables 41 and Table 42 below:

TABLE 41

| treatment | | T30% G70% | T50% G50% | T70% G30% |
|---|---|---|---|---|
| 1½ | hours | 0 | 0 | 0 |
| 3 | hours | 0 | 0 | 0 |
| 4 | hours | 0 | 0 | 0 |
| 5 | hours | 0 | 0 | 0 |
| 7 | hours | 0 | 0 | 0 |
| 8 | hours | 0.25 | 0 | 0.25 |
| 23 | hours | 28.5 | 6.5 | 19.5 |

where G is glycerine and T is Transcutol ®P.

TABLE 42

| control | | T30% G70% | T50% G50% | T70% G30% |
|---|---|---|---|---|
| 1½ | hours | 0 | 0 | 0 |
| 3 | hours | 0 | 0 | 0 |
| 4 | hours | 0 | 0 | 0.25 |
| 5 | hours | 0 | 0 | 9 |
| 7 | hours | 0.75 | 0.5 | 9.25 |
| 8 | hours | 1.75 | 0.5 | 10.5 |
| 23 | hours | 38.5 | 29.5 | 36.5 |

where G is glycerine and T is Transcutol ®P.

These results show that there was 8 hours of protection with the treatment. The mixture of 50% transcutol (T) and 50% glycerine (G) showed protection even without an active principle.

The following Tables 43 and 44 are summaries of the experiments:

### Tests at 1 hour (1 h40)

TABLE 43

| | MOS007 | | MOS009 | | | |
|---|---|---|---|---|---|---|
| | Treat- | | treat- | | MOS010 | |
| treatment | ment | control | ment | control | treatment | control |
| Number | 12 | 12 | 8 | 8 | 16 | 16 |
| of horses | | | | | | |
| Total | 52 | 98 | 7 | 46.5 | 12 | 121.5 |
| Average | 4.33 | 8.16 | 0.88 | 5.81 | 0.75 | 7.59 |
| P value | 12.31% | 12.31% | 5.39% | 5.39% | 0.09% | 0.09% |

Table 44 shows the tests at 1 hour (1 h40) and the constancy of the control average.

TABLE 44

| treat- | MOS011 | | MOS013 | | MOS014 | |
|---|---|---|---|---|---|---|
| ment | Treatment | control | treatment | control | treatment | control |
| Number | 3 | 3 | 3 | 3 | 6 | 6 |
| of | | | | | | |
| horses | | | | | | |
| Total | 0 | 23.5 | 0 | 0 | 0 | 0 |
| Average | 0 | 7.83 | 0 | 0 | 0 | 0 |
| P value | 11.45% | 11.45% | — | — | — | — |

The summary of the tests made upon horses is set forth in Table 45 below:

TABLE 45

| | MOS011 | | | | | | | | | |
|---|---|---|---|---|---|---|---|---|---|---|
| | | Gel | MOS013 | | | | MOS014 | | | |
| | Gel with | with | | | 30% T | 30% T | 50% T | 50% T | 70% T | 70% T |
| Time | water | water | 100% T | 100% T | 70% G | 70% G | 50% G | 50% G | 30% G | 30% G |
| hours | semiochemical | control | semiochemical | control | semiochemical | control | semiochemical | control | semiochemical | control |
| 1½ | 0.00 | 7.83 | 0 | 0 | 0 | 0 | 0 | 0 | 0 | 0 |
| 3 | 1.17 | 8.17 | 0 | 0 | 0 | 0 | 0 | 0 | 0 | 0 |
| 4 | — | — | — | — | 0 | 0 | 0 | 0 | 0 | 0.25 |
| 5 | 4.00 | 13.83 | 0 | 4 | 0 | 0 | 0 | 0 | 0 | 9 |
| 7 | 3.17 | 12.50 | 0.17 | 8.83 | 0 | 0.75 | 0 | 0.5 | 0 | 9.25 |
| 8 | — | — | — | — | 0.25 | 1.75 | 0 | 0.5 | 0.25 | 10.5 |
| 23 | — | — | — | — | 28.5 | 38.5 | 6.5 | 29.5 | 19.5 | 36.5 |

H. Testing of MOS-22

The aim of this study was to evaluate the effect of the semiochemical product MOS-22 on the infestation of horses by Simuliidae sp during a duration of from 0 hours (H0) to 22 hours (H22) after treatment. This was a test with 10 horses in a region where there was a river close to the horse pasture. The time between the application of the product and the gel was at hours 0, 10, 11, 12, 13, 14, 20, 21 and 22.

Both treatment and time are considered as within-subject factors; a mixed model for two within-subject factors corresponds with a strip-plot design model. The random effects define the three different-sized “experimental units” in this model, allowing covariances to vary due to the subject, treatment, and time. This will result in covariances among each of the 18 measurements for a given horse, though different horses are still assumed to be independent. This analysis was realized with the SAS PROC mixed procedure.

Ten horses were treated with either a control (treatment A) or with the semiochemical product (treatment B). The treated group B contained the active semiochemical composition and an excipient, 1.155 g of 3-cyclopentyl propionic acid, 1.135 g of cyclohexyl propionic acid were weighed in a 100 ml beaker, solubilized with 7.500 g of Transcutol® P and homogenized. 65.305 g of polyglycerol-4 was added and the chemicals were mixed vigorously to thoroughly homogenize these chemicals and stirred with a spatula for several minutes.

Solution A, containing the control, was obtained by weighing 7.505 g of Transcutol® P and 67.695 g of polyglycerol-4 in a 100 ml beaker, homogenizing this mixture and stirring with a spatula for several minutes.

Descriptive statistics was undertaken for treatments A and B. The results are shown in Tables 46 and 47 below:

TABLE 46

| | | N | | | | | |
|---|---|---|---|---|---|---|---|
| Variable | N | Miss | Mean | Median | Std Dev | Minimum | Maximum |
| H0 | 10 | 0 | 3.2000000 | 1.0000000 | 6.8847658 | 0 | 22.5000000 |
| H10 | 10 | 0 | 14.1000000 | 1.0000000 | 20.9812085 | 0 | 49.5000000 |
| H11 | 10 | 0 | 17.6500000 | 0.5000000 | 23.4533224 | 0 | 57.5000000 |
| H12 | 10 | 0 | 31.1500000 | 27.5000000 | 30.1229425 | 0 | 85.0000000 |
| H13 | 10 | 0 | 36.9000000 | 41.2500000 | 24.8951133 | 0 | 65.0000000 |
| H14 | 9 | 1 | 34.1666667 | 35.0000000 | 19.0279400 | 0 | 61.5000000 |
| H20 | 10 | 0 | 25.6000000 | 23.7500000 | 17.6867810 | 3.0000000 | 64.5000000 |
| H21 | 10 | 0 | 40.8000000 | 38.7500000 | 21.3895094 | 9.0000000 | 82.0000000 |
| H22 | 10 | 0 | 35.9500000 | 32.5000000 | 21.8459887 | 10.0000000 | 85.5000000 |

where H refers to hour. The treatment is A (control).

TABLE 47

| | | N | | | | | |
|---|---|---|---|---|---|---|---|
| Variable | N | Miss | Mean | Median | Std Dev | Minimum | Maximum |
| H0 | 10 | 0 | 4.9000000 | 1.0000000 | 12.3845782 | 0 | 40.0000000 |
| H10 | 10 | 0 | 2.9000000 | 0 | 9.1706052 | 0 | 29.0000000 |
| H11 | 10 | 0 | 4.8000000 | 0 | 10.3338710 | 0 | 31.5000000 |
| H12 | 10 | 0 | 8.3000000 | 0 | 13.6548730 | 0 | 32.5000000 |
| H13 | 10 | 0 | 10.0500000 | 0 | 16.5100138 | 0 | 41.5000000 |
| H14 | 9 | 1 | 11.0555556 | 0.5000000 | 17.4023067 | 0 | 46.5000000 |
| H20 | 10 | 0 | 10.9500000 | 2.0000000 | 15.0267354 | 0 | 36.5000000 |
| H21 | 10 | 0 | 16.4500000 | 5.0000000 | 21.2203388 | 0 | 58.5000000 |
| H22 | 10 | 0 | 16.7000000 | 15.2500000 | 16.5633464 | 0 | 48.5000000 |

where H refers to hour. The treatment is B (the semiochemical).

For treatments A & B, standard deviation was often superior to the mean & the median. Data were scattered but this is the way the treatment acts in this particular field context. That's why Wilcoxon Signed Rank test was used in the first part of data analysis and data submitted to Box-Cox transformation in order to run a mixed model (λ=−0.02).

The following Table 48 shows a BOX-COX transformation results for MOS-22.

TABLE 48

Transformation of Box-Cox
MOS22.1analysis

| Variable(s) | simuliidae_+1 | simuliidae_+1 |
|---|---|---|
| transformed | original | transformed |
| 1 | 1.00000 | 0.000000 |
| 2 | 4.50000 | 1.486463 |
| 3 | 3.50000 | 1.240527 |
| 4 | 2.50000 | 0.909733 |
| 5 | 1.00000 | 0.000000 |
| 6 | 1.00000 | 0.000000 |
| 7 | 2.50000 | 0.909733 |
| 8 | 2.00000 | 0.689390 |
| 9 | 1.00000 | 0.000000 |
| 10 | 1.00000 | 0.000000 |
| 11 | 23.50000 | 3.080060 |
| 12 | 41.00000 | 3.607419 |
| 13 | 4.50000 | 1.486463 |
| 14 | 2.00000 | 0.689390 |
| 15 | 3.00000 | 1.089195 |
| 16 | 2.00000 | 0.689390 |
| 17 | 1.00000 | 0.000000 |
| 18 | 2.00000 | 0.689390 |
| 19 | 1.00000 | 0.000000 |
| 20 | 1.00000 | 0.000000 |
| 21 | 33.00000 | 3.402295 |
| 22 | 1.00000 | 0.000000 |
| 23 | 50.50000 | 3.803699 |
| 24 | 1.00000 | 0.000000 |
| 25 | 30.00000 | 3.312007 |
| 26 | 50.00000 | 3.794342 |
| 27 | 9.50000 | 2.211981 |
| 28 | 1.00000 | 0.000000 |
| 29 | 1.00000 | 0.000000 |
| 30 | 2.50000 | 0.909733 |
| 31 | 1.00000 | 0.000000 |
| 32 | 1.00000 | 0.000000 |
| 33 | 1.00000 | 0.000000 |
| 34 | 1.00000 | 0.000000 |
| 35 | 1.00000 | 0.000000 |
| 36 | 1.00000 | 0.000000 |
| 37 | 1.00000 | 0.000000 |
| 38 | 1.50000 | 0.404178 |
| 39 | 1.00000 | 0.000000 |
| 40 | 1.00000 | 0.000000 |
| 41 | 49.00000 | 3.775340 |
| 42 | 2.50000 | 0.909733 |
| 43 | 58.50000 | 3.941814 |
| 44 | 15.00000 | 2.651305 |
| 45 | 32.50000 | 3.387842 |
| 46 | 1.00000 | 0.000000 |
| 47 | 34.50000 | 3.444359 |
| 48 | 1.00000 | 0.000000 |
| 49 | 2.00000 | 0.689390 |
| 50 | 37.50000 | 3.523181 |
| 51 | 1.00000 | 0.000000 |
| 52 | 1.00000 | 0.000000 |
| 53 | 1.00000 | 0.000000 |
| 54 | 1.00000 | 0.000000 |
| 55 | 1.00000 | 0.000000 |
| 56 | 1.00000 | 0.000000 |
| 57 | 1.00000 | 0.000000 |
| 58 | 1.00000 | 0.000000 |
| 59 | 1.00000 | 0.000000 |
| 60 | 2.00000 | 0.689390 |
| 61 | 86.00000 | 4.302204 |
| 62 | 20.50000 | 2.949948 |
| 63 | 62.00000 | 3.996302 |
| 64 | 31.50000 | 3.358244 |
| 65 | 33.50000 | 3.416529 |
| 66 | 63.00000 | 4.011296 |
| 67 | 28.50000 | 3.263361 |
| 68 | 1.00000 | 0.000000 |
| 69 | 1.50000 | 0.404178 |
| 70 | 40.00000 | 3.584120 |
| 71 | 1.00000 | 0.000000 |
| 72 | 1.00000 | 0.000000 |
| 73 | 1.00000 | 0.000000 |
| 74 | 1.00000 | 0.000000 |
| 75 | 1.00000 | 0.000000 |
| 76 | 5.00000 | 1.589280 |
| 77 | 1.00000 | 0.000000 |
| 78 | 28.50000 | 3.263361 |
| 79 | 1.00000 | 0.000000 |
| 80 | 6.50000 | 1.844574 |
| 81 | 56.00000 | 3.900827 |
| 82 | 31.00000 | 3.343085 |
| 83 | 65.50000 | 4.047751 |
| 84 | 42.50000 | 3.641307 |
| 85 | 30.00000 | 3.312007 |
| 86 | 30.00000 | 3.312007 |
| 87 | 33.50000 | 3.416529 |
| 88 | 1.00000 | 0.000000 |
| 89 | 1.00000 | 0.000000 |
| 90 | 66.00000 | 4.054872 |
| 91 | 18.50000 | 2.851968 |
| 92 | 1.00000 | 0.000000 |
| 93 | 1.00000 | 0.000000 |
| 94 | 1.00000 | 0.000000 |
| 95 | 1.00000 | 0.000000 |
| 96 | 1.00000 | 0.000000 |
| 97 | 1.00000 | 0.000000 |
| 98 | 56.50000 | 3.909171 |
| 99 | 1.00000 | 0.000000 |
| 100 | 51.00000 | 3.812963 |
| 101 | 62.50000 | 4.003830 |
| 102 | 29.00000 | 3.279860 |
| 103 | 59.00000 | 3.949798 |
| 104 | 47.50000 | 3.746084 |
| 105 | 25.00000 | 3.138916 |
| 106 | 36.00000 | 3.484604 |
| 107 | 21.00000 | 2.972925 |
| 108 | 1.50000 | 0.404178 |
| 109 | 1.00000 | 0.000000 |
| 110 | 42.50000 | 3.641307 |
| 111 | 23.00000 | 3.059590 |
| 112 | 1.00000 | 0.000000 |
| 113 | 1.00000 | 0.000000 |
| 114 | 1.00000 | 0.000000 |
| 117 | 1.00000 | 0.000000 |
| 118 | 38.00000 | 3.535693 |
| 119 | 1.50000 | 0.404178 |
| 120 | 33.50000 | 3.416529 |
| 121 | 32.50000 | 3.387842 |
| 122 | 3.50000 | 1.240527 |
| 123 | 21.00000 | 2.972925 |
| 124 | 37.00000 | 3.510499 |
| 125 | 37.50000 | 3.523181 |
| 126 | 21.00000 | 2.972925 |
| 127 | 34.00000 | 3.430548 |
| 128 | 12.50000 | 2.476320 |
| 129 | 2.50000 | 0.909733 |
| 130 | 65.50000 | 4.047751 |
| 131 | 12.00000 | 2.437072 |
| 132 | 1.00000 | 0.000000 |
| 133 | 4.00000 | 1.371321 |
| 134 | 1.00000 | 0.000000 |
| 135 | 1.00000 | 0.000000 |
| 136 | 9.50000 | 2.211981 |
| 137 | 1.00000 | 0.000000 |
| 138 | 28.50000 | 3.263361 |
| 139 | 22.50000 | 3.038663 |
| 140 | 38.00000 | 3.535693 |
| 141 | 83.00000 | 4.269086 |
| 142 | 5.50000 | 1.682143 |
| 143 | 59.00000 | 3.949798 |
| 144 | 59.50000 | 3.957713 |
| 145 | 44.00000 | 3.674001 |
| 146 | 46.50000 | 3.726054 |
| 147 | 33.50000 | 3.416529 |
| 148 | 15.00000 | 2.651305 |
| 149 | 6.50000 | 1.844574 |
| 150 | 58.50000 | 3.941814 |
| 151 | 29.00000 | 3.279860 |
| 152 | 1.00000 | 0.000000 |
| 153 | 10.00000 | 2.261474 |
| 154 | 1.00000 | 0.000000 |
| 155 | 5.00000 | 1.589280 |
| 156 | 20.00000 | 2.926394 |
| 157 | 1.00000 | 0.000000 |
| 158 | 32.50000 | 3.387842 |
| 159 | 36.00000 | 3.484604 |
| 160 | 46.00000 | 3.715875 |
| 161 | 86.50000 | 4.307610 |
| 162 | 24.00000 | 3.100093 |
| 163 | 45.00000 | 3.695174 |
| 164 | 49.50000 | 3.784890 |
| 165 | 40.00000 | 3.584120 |
| 166 | 21.50000 | 2.995354 |
| 167 | 36.00000 | 3.484604 |
| 168 | 8.50000 | 2.104523 |
| 169 | 14.00000 | 2.585147 |
| 170 | 52.50000 | 3.840209 |
| 171 | 11.00000 | 2.353332 |
| 172 | 1.00000 | 0.000000 |
| 173 | 22.00000 | 3.017259 |
| 174 | 1.00000 | 0.000000 |
| 175 | 19.00000 | 2.877437 |
| 176 | 19.50000 | 2.902234 |
| 177 | 1.50000 | 0.404178 |
| 178 | 44.50000 | 3.684648 |
| 179 | 18.50000 | 2.851968 |
| 180 | 31.00000 | 3.343085 |

The following Table 49 summarizes the data set forth above in Table 48.

A typical values were then considered. Methodology in order to search atypical values consists in centering and reduction of data and is considered atypical when each centered-reduced value is superior to 3 in absolute value.

One horse (horse 1) showed a standard value superior to 3 (3.10) at the 12 hour treatment A which corresponds to a number of Simuliidae of 85 and a standard value superior to 3 (3.12) at the 22 hour treatment A which corresponds to a number of Simuliidae of 85.5.

It was decided to keep these 2 values in the dataset because of the reduced sample size and the non-improvement of normality of residues.

The following Table 50 shows the results of a Wilcoxon Signed Rank test.

These results show that everything is significant in favor of treatment B at the exception of hour 0, hour 11 and hour 20.

A mixed model raw data was then calculated on the residues to test for normality.

The data is shown in Table 51 below. According to the data set forth in Table 51 below normality of residues was not encountered.

The following Table 52 shows the mixed model for two within-subject factors results.

Everything is significant in Table 52.

The following Table 53 shows the difference of least squares means.

Whether on raw data or with transformed data, everything was significant.

Concerning especially post hoc multiple mean comparisons, the two Tables 54 and 55 are set forth below (one for raw data and one for transformed data) in order to sum up the results of differences of Least Squares Means with the Tukey-Kramer adjustment if the effective were unbalanced (H14 in the present study). Only significant results were introduced in the tables.

### Raw Data:

The effect of treatment factor was significant and in favor of group B. The effect of time factor is highly significant; differences were observed between:

H0 & H12, H13, H14, H20, H21, H22

H10 & H12, H13, H14, H20, H21, H22

H11 & H13, H20, H21, H22

H12 & H21, H22,

H13 & H21, H22.

The effect of the interaction is highly significant; differences are set forth in Table 54 below:

Everything was significant in favor of treatment B at the exception of H0, H10, H11 & H14.

Transformed Data:

The effect of treatment factor was significant and in favor of group B.

The effect of time factor was highly significant; differences were observed between:

H0 & H12, H13, H14, H20, H21, H22

H10 & H12, H13, H14, H20, H21, H22

H11 & H13, H20, H21, H22

H12 & H21, H22,

H13 & H21, H22.

The effect of the interaction was significant; differences were observed as set forth in Table 55 below:

Everything was significant in favor of treatment B with the exception of H0 & H11.

I. Testing of MOS-023

The aim of this study was to evaluate the effect of the semiochemical product on the infestation of horses by Simuliidae sp across time (from hour 8 (H8) until hour 10 (H10) after treatment. This was a test with 10 horses in a region where there was a river close to the horse pasture. The time between the application of the product and the gel was hours 8, 9 and 10.

Both treatment and time are considered as within-subject factors; a mixed model for two within-subject factors corresponds with a strip-plot design model. The random effects define the three different-sized “experimental units” in this model, allowing covariances to vary due to the subject, treatment and time. This analysis was realized using the SAS PROC mixed procedure.

The horses were treated with either a control (treatment A) or with the semiochemical product (treatment B). The treated group B contained the active semiochemical composition and an excipient, 1.150 g of 3-cyclopentyl propionic acid, 1.130 g of cyclohexyl propionic acid were weighed in a 100 ml beaker, solubilized with 7.500 g of Transcutol® P and homogenized. 65.410 g of polyglycerol-4 was added and the chemicals were mixed vigorously to thoroughly homogenize these chemicals and stirred with a spatula for several minutes.

Solution A, containing the control, was obtained by weighing 7.525 g of Transcutol® P and qsp'd with 75.015 g of polyglycerol-4 in a 100 ml beaker, homogenizing this mixture and stirred with a spatula for several minutes.

The horse number 3 was removed from the analysis because no Simuliidae sp was found on it during the whole trial.

The results of an unblinded study treatment A=control; treatment B=semiochemical is shown in FIGS. 56 and 57 below:

Semiochemical
Control

In the treatment for the control and semiochemical the standard deviation was always superior to the mean and the median. Data were scattered but this is the way the treatment acts in this particular field context. That's why Wilcoxon Signed Rank test was used in the first part of data analysis and data submitted to Box-Cox transformation in order to run a mixed model (λ=−0.67).

The BOX-COX transformation data are set forth in: Table 58 below:

TABLE 58

Box-Cox transformation

| | Nb_simuliidae | Nb_simuliidae |
|---|---|---|
| Transformed variable | (original) | (transformed) |
| 1 | 0.00000 | 0.000000 |
| 2 | 0.00000 | 0.000000 |
| 3 | 0.00000 | 0.000000 |
| 4 | 0.00000 | 0.000000 |
| 5 | 0.00000 | 0.000000 |
| 6 | 2.00000 | 0.777932 |
| 7 | 13.00000 | 1.238811 |
| 8 | 0.00000 | 0.000000 |
| 9 | 0.00000 | 0.000000 |
| 10 | 2.00000 | 0.777932 |
| 11 | 0.00000 | 0.000000 |
| 12 | 7.00000 | 1.122725 |
| 13 | 20.00000 | 1.299541 |
| 14 | 0.00000 | 0.000000 |
| 15 | 0.50000 | 0.355113 |
| 16 | 0.00000 | 0.000000 |
| 17 | 1.00000 | 0.554614 |
| 18 | 29.50000 | 1.342598 |
| 19 | 0.00000 | 0.000000 |
| 20 | 0.50000 | 0.355113 |
| 21 | 0.00000 | 0.000000 |
| 22 | 2.00000 | 0.777932 |
| 23 | 0.00000 | 0.000000 |
| 24 | 14.00000 | 1.250342 |
| 25 | 24.00000 | 1.320997 |
| 26 | 0.00000 | 0.000000 |
| 27 | 0.00000 | 0.000000 |
| 28 | 0.00000 | 0.000000 |
| 29 | 0.50000 | 0.355113 |
| 30 | 20.50000 | 1.302585 |
| 31 | 45.00000 | 1.379086 |
| 32 | 0.00000 | 0.000000 |
| 33 | 4.50000 | 1.016816 |
| 34 | 0.00000 | 0.000000 |
| 35 | 0.00000 | 0.000000 |
| 36 | 0.00000 | 0.000000 |
| 37 | 0.50000 | 0.355113 |
| 38 | 0.00000 | 0.000000 |
| 39 | 0.00000 | 0.000000 |
| 40 | 14.50000 | 1.255638 |
| 41 | 0.00000 | 0.000000 |
| 42 | 27.50000 | 1.335551 |
| 43 | 47.00000 | 1.382324 |
| 44 | 0.00000 | 0.000000 |
| 45 | 0.00000 | 0.000000 |
| 46 | 5.50000 | 1.067326 |
| 47 | 0.00000 | 0.000000 |
| 48 | 26.50000 | 1.331710 |
| 49 | 58.50000 | 1.397324 |
| 50 | 0.00000 | 0.000000 |
| 51 | 13.50000 | 1.244742 |
| 52 | 0.00000 | 0.000000 |
| 53 | 0.00000 | 0.000000 |
| 54 | 33.50000 | 1.354612 |

The methodology in order to search atypical values consists in centering and reduction of data. Data is considered atypical if each centered-reduced value is superior to 3 in an absolute value. One horse (horse 8) showed a standard value superior to 3 (3.66) at “H10/semiochemical” which corresponded to a number of Simuliidae of 58.5. It was decided to keep this value in the dataset because of the reduced sample size & the non-improvement of normality of residues.

Wilcoxon Signed Rank Test results are set forth in the Table 60 below:

Everything was significant in favor of the semiochemical treatment.

The mixed model raw data for residues is set forth in Table 61 below:

A mixed model for two within-subject factors results are set forth in Table 62 below:

Everything was significant in Table 62.

The differences of least square means is set forth in Table 63 below:

The mixed model raw data for residues is set forth in Table 64 below:

According to Shapiro-Wilk, Kolmogorov-Smirnov, Cramer-Von-Mises & Anderson-Darling and the graphical representation, normality of residues is not encountered.

The mixed model for two within-subject factors results are set forth in Table 65 set forth below:

The treatment and the interaction time*treatment were significant. The time was not significant in Table 65.

The differences of least squares means is set forth in Table 66 below:

Conclusion

Everything was significant on raw data. On transformed data, treatment and the interaction treatment*time were significant. The effect of time was not significant.

### Raw Data:

The effect of treatment factor was significant and in favor of the semiochemical treatment.

The effect of time factor was significant; differences were observed between H8 & H10, H9 & H10.

The effect of the interaction was significant at H10 in favor of the semiochemical treatment.

### Transformed Data:

The effect of treatment factor was significant and in favor of the semiochemical treatment.

The effect of time factor was not significant.

The effect of the interaction was significant at H8, H9, and H10 in favor of the semiochemical treatment.

### Example 10

### Experimental Testing of the Efficacy in Humans

A-Testing of MOS-005

300 μg/cm² of a mixture of 50% 3-cyclopentyl propionic acid and 50% 3-cyclohexyl propionic acid in solution against Aedes aegypti was tested in humans.

The mosquitoes utilized in the experiment were Aedes aegypti (Diptera Culicidae; Say 1823) strain ROCK. These mosquitoes were female having a post-age emergence between 4 and 12 days. They have never before had a blood meal.

The criteria for the volunteers used in this study was that they are (1) human and signed a consent form, (2) the volunteers have not drank or smoked within 6 hours before the test, (3) the volunteers are not pregnant or of age 16 years or less or a person more than 60 years old, (4) the individual is not allergic to the treatment or to mosquito bites, (5) no insecticidal products were used by the individual 8 hours before the test and (6) an individual who was sick or weak or an individual who has performed physical activity just before the test was excluded.

The testing was effectuated in a closed room at a temperature of 27° C.±2° C. and a relative humidity of 70% (±10%). The period of photophase was 15 hours and the scotophase was 9 hours before twilight. The artificial dawn lasted one hour. The tests were performed during scotophase between 3 and 5 hours in the morning. Prior to beginning the test the closed room was lighted by a red light (spectra >650 nm).

The experimental cage that was used in the experiment was composed of a rectangular metal structure having the dimension 315×315×430 mm in which a sheer mosquito net is fitted. The sleeves of the net were closed with rubber bands to prevent light from entering the cages. Two walls of the cage were closed with plexiglass to observe and film the behavior of the mosquitoes. A camera was installed facing the side of insertion of the arm in the cage. The camera overlooked the treatment zone and was on a tripod.

In the cage the mosquitoes had a piece of cotton soaked in tap water.

On the eve before the tests the mosquitoes were transferred to the experimental cage with the aid of an entomologic mouth aspirator. 50 mosquitoes were placed in each cage. The number of mosquitoes aspirated from the breeding cage was counted with the aid of a mechanical counter.

The biting zone in this example was the zone which was treated. It was found on the front side of the forearm; 3 cm from the crease of the elbow and it extended 5 cm in width and 7 cm in length. In this case only the forearm of the volunteer was treated and hence the non treated zones were protected by the installation template. The installation template was constituted of a piece of transparent, flexible plastic having a dimension of 300×350 mm in which a rectangle of 7 cm by 5 cm was cut. It is a physical barrier to any mosquito bites and ensures that the mosquitoes bite only in the zone of the person which was treated or administered the placebo as a control.

The control solution was 15%Tween®80, 12% glycerol and 70% deionized to and sterilized water. The treatment was a mixture of 3-cyclopentyl propionic acid and 3-cyclohexyl propionic acid at a concentration of 3%. These 2 molecules were mixed equally (wt %/wt %) in an excipient of 15% Tween®80, 12% glycerine and 70% deionized and sterilized water.

The semiochemical solution was obtained by weighing in a beaker 0.030 g of 3-cyclopentyl propionic acid, 0.030 g of 3-cyclohexyl propionic acid 14.015 g of deionized sterile water, 3.015 g of Tween® 80 and 2.410 g of glycerol. The chemicals were mixed with an Ultra turrax homogenizer at speed 3.The semiochemical composition was present in the final formulation at a concentration of 3% (wt %).

The control solution 2 was obtained by weighing in a 100 ml beaker 14.615 g of sterile water, 3.010 g of Tween® 80 and 2.405 of glycerine. The chemicals were mixed with an Ultra turrax homogenizer at speed 2.

The treatments were maintained in glass flasks, at ambient temperature and were protected from light. The quantity of treatment that was applied was 0.63 ml on a surface of 63 cm².

Each day of the test 2 syringes containing 0.63 ml of treatment were prepared and were applied to a 63 cm² surface. Prior to being aspirated into the syringes, the glass flasks were vigorously shaken for 10 seconds to homogenize the solutions. 1 syringe containing the treatment and 1 syringe containing the control were prepared.

Prior to applying the treatment or placebo as control, the arms of the volunteer were first washed with odorless soap, rinsed with tap water, rinsed with 70% ethanol and dried with the aid of absorbent paper.

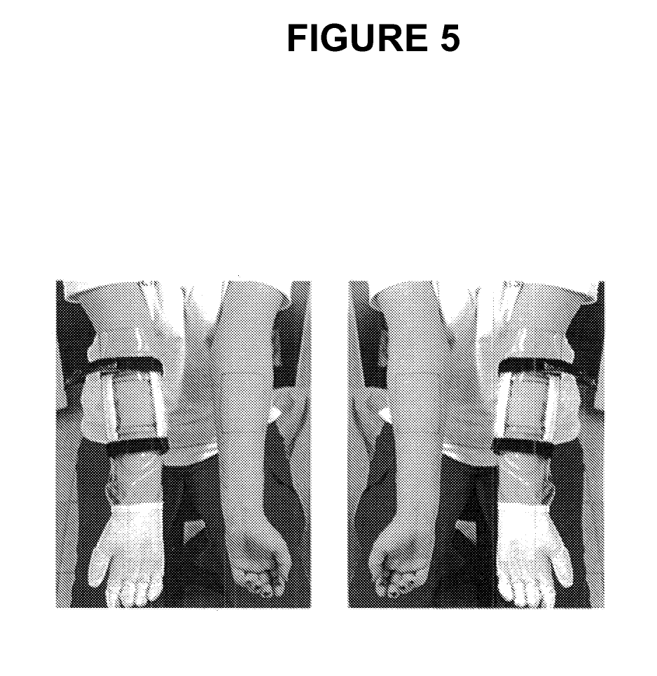

The zone that the treatment was applied is in the form of a rectangle of 63 cm². It is situated on the inside of the forearm at 2 cm above the bend of the elbow in the middle of the forearm and privileges hairless areas. This zone extends 7 cm wide and 9 cm long on the forearm (See, FIG. 5).

For eliminating any errors, the limits of this zone were made using a pen to trace a stencil made of plastic and having an opening. The opening measured 7×9 cm.

Two arms of the volunteer were used; one arm for the control and the other arm for the treatment (See, FIG. 5). The technician donning vinyl gloves took the syringe and applied 0.1 ml to the center of the zone in the center of the shaved area and spreads the treatment on the surface in the form of a spiral (see 1 below).

With the remaining 0.4 ml the technicians places it on the volunteer and streaks the solutions 2 times in the manner shown in 2, 3 and 4 below:

After treating the forearm with the control or treatment the installation template was fixed. The plastic sheet covered the forearm from the elbow to the wrist. A non-powdered vinyl glove was used to cover the hand of the volunteer. 2 velcro® straps enclosed the arm from the wrist and the elbow.

The volunteers were seated on a stool in the inside of a room in which the temperature and humidity were stable during the test. The testing was effectuated in a closed room at a temperature of 27° C.±2° C. and a relative humidity of 70% (±10%). The period of photophase was 15 hours and the scotophase was 9 hours before twilight. The artificial dawn lasted one hour. The tests were performed during scotophase between 3 and 5 hours in the morning. Prior to beginning the test the closed room was lighted by a red light (spectra >650 nm).

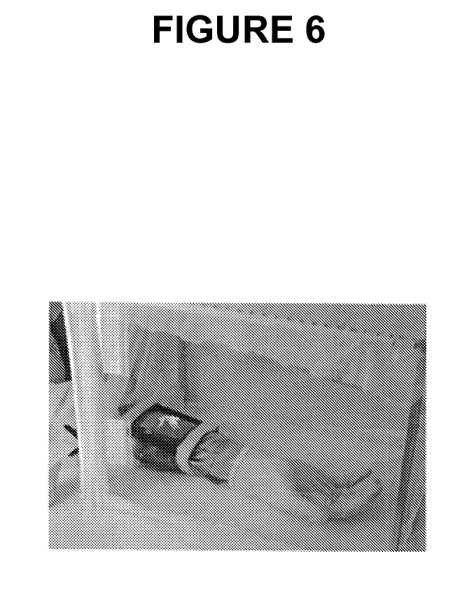

A dust mask was placed over the mouth and nose of the volunteer to ensure that breathing does not disturb the behavior of the mosquitoes. The study was filmed when the volunteer placed his/her arm in the cage (see, FIG. 6). Once the arm was in the cage, the technician aided the volunteer to tie the elastic shutting out the light from the testing cage. Once inserted a stop watch was started.

The volunteer and two technicians observed the behavior of the mosquitoes in the presence of the treated zone and observed in particular whether the mosquitoes landed on the treated zone. When a mosquito landed on the treated zone and remained for 1 second, it was considered that the mosquito wants to bite. The volunteer then shaked his/her arm to scare the mosquito and the time elapsed since the start of the test was recorded using a stop watch. After the mosquito was scared off the volunteer pulled his/her arm slightly off the bottom of the cage and effectuated a short shake.

When a second mosquito landed on the treated zone and rested for more than 1 second the time elapsed since the start of the test was recorded using a stop watch. The technician shaked the arm of the volunteer to ward off the mosquito and pulled the arm out of the cage.

If after 30 minutes a second mosquito does not land on the treatment zone, the test was stopped and it was indicated that the second mosquito did not land after 30 minutes.

Once the test was terminated the arms were washed using odorless soap, and rinsed with tap water, washed again with odorless soap and rinsed in tap water and then dried with an absorbent paper.

6 volunteers, each volunteer tested 3 times with a different group of 50 mosquitoes with a minimum of 48 hours between the tests. In the first test the forearm 1 was the right arm, while in the second test the forearm 1 is the left arm and in the final test the forearm 1 was the right arm. Thus 900 total mosquitoes were used in this example.

The mosquitoes were then aspirated from the test cage and killed by freezing at −10° C. for 15 minutes.

As a control video tapes were used to ensure that there was no doubt concerning the results in combination with direct observation during the test.

The results revealed that a dose of 300 μg/cm² applied to human permitted an efficiency of protection of 89% during 30 minutes against the mosquitoes Aedes aegypti. During 13 minutes human subjects were protected around 95%. 80% of the persons were protected 100% for more than 30 minutes.

B-Testing of MOS-006

The same conditions were those set for above for MOS-005 in Example 10 A, except the mosquitoes used in this test were female Anopheles gambiae (Diptera: Culicidae; Say 1823) strain G3.

The semiochemical solution was obtained by weighing in a beaker 0.030 g of 3-cyclopentyl propionic acid, 0.030 g of 3-cyclohexyl propionic acid 14.015 g of sterile water, 3.015 g of Tween® 80 and 2.410 g of glycerine. The chemicals were mixed with an Ultra turrax homogenizer at speed 3.

The semiochemical composition was present in the final formulation at a concentration of 3% (wt %).

The control solution was obtained by weighing in a 100 ml beaker 14.615 g of sterile water, 3.010 g of Tween® 80 and 2.405 of glycerine. The chemicals were mixed with an Ultra turrax homogenizer at speed 2.

Six volunteers were tested with one test and 3 treatments 300 μg/cm² was the concentration of the dose tested.

A comparison of results for MOS005 and MOS006 are shown in Table 46 below:

TABLE 67

| | Human | | Human | | |
|---|---|---|---|---|---|
| | volunteer | Control | volunteer | control | control |
| | MS005 | MS005 | MOS006 | MS006 | −2values |
| Number of | 18 | 18 | 6 | 6 | 4 |
| tests | | | | | |
| Average | 10 | 35 | 17 | 100 | 33.5 |
| Median | 6.5 | 28.5 | 14 | 41 | 31.5 |
| Minimum | 2 | 5 | 2 | 23 | 23 |
| maximum | 34 | 72 | 40 | 249 | 48 |
| Standard | 9 | 24 | 15.01 | 103.84 | 10.66 |
| deviation | | | | | |

The above shows that there was 100% efficiency with the semiochemical composition during 30 minutes.

### Example 11

### Experimental Testing of the Efficacy in Sheep

The objective of this assay was to evaluate the effect of a semiochemical solution versus control to prevent the biting and landing of mosquitoes on sheep in a barn for breeding animals. All of the testing was done on sheep in headlocks. Six sheep received both the semiochemical solution and the control at the left and the right sides as spots on their bodies. A, containing the control of 73% deionized and sterilized water, 15% Tween® and 12% glycerine and the product B the semiochemical solution containing a mixture of 3-cyclopentyl propionic acid and 3-cyclohexyl propionic acid at a final concentration of 3%. These 2 molecules were mixed equally (50% wt %/50% wt %) in an excipient of 70% deionized and sterilized water, 15% Tween and 12% glycerine.

The semiochemical solution (B) was obtained by weighing in a beaker 1.535 g of 3-cyclopentyl propionic acid, 1.510 g of 3-cyclohexyl propionic acid, 70.010 g of deionized sterile water, 15.035 g of Tween and 12.140 g of glycerine. The chemicals were mixed with an Ultra turrax homogenizer at speed 3 in a 100 ml beaker.

The control solution (A) was obtained by weighing in a 100 ml beaker, 73.005 g deionized sterile water, 15.015 g Tween and 12.045 g. The chemicals were mixed with an Ultra turrax homogenizer at speed 3.

Half of the sheep received the treatment at their right side and half of the sheep received the control at their left side. In the other half the sheep received the treatment at their left side and the control at their right side. The assay was a semi-blinded assay.

In this example the influence of the mixture of the semiochemical composition was tested on the mosquito bites of Aedes aegypti (Diptera Culicidae; Say 1823) strain ROCK.

A flock of six female sheep with an age of between 1 and 9 years were used. Two sides of each sheep were tested; one side with the control (A) and the other side with the semiochemical solution (B). Therefore 12 total tests were performed.

To include the sheep in this study they must not have had (1) any antiparasitic treatment for 3 months; (2) the sheep were not used in the experiment for more than 2 hours; and (3) the sheep must have weighed between 40 kg to 60 kg. The sheep were also raised on the experimentation site.

The mosquitoes that were used in the test were Aedes aegypti (Diptera: Culcidae; Say 1823) strain ROCK, which were bred at IRSEA (Apt, France) in a closed room at a temperature of 27° C.±2° C. and a relative humidity of 70%. The mosquitoes that were used were females having a post-emergence age between 4 and 12 days. They never had before a blood meal.

The day before the test 3 sheep were selected from two different sheep farms. Thus 6 total sheep. The sheep did not receive any treatment for 3 weeks and did not show any signs of weakness or pathology. They each received a number which corresponded to the number on the test chamber of the mosquitoes. The tests were effectuated in a building for animal breeding and were handled and manipulated in a calm environment.

On the day before the test the mosquitoes were placed in a closed space and maintained in a breeding room having a temperature of 20° C.±1° C. up until their utilization (±20 hours). The mosquitoes were subjected to water by adding a piece of cotton wool saturated with water to their enclosure. Just up until the test, the mosquitoes were under artificial light. The period of protophase was 15 hours and scotophase was 9 hours with a twilight and artificial dawn of 1 hour.

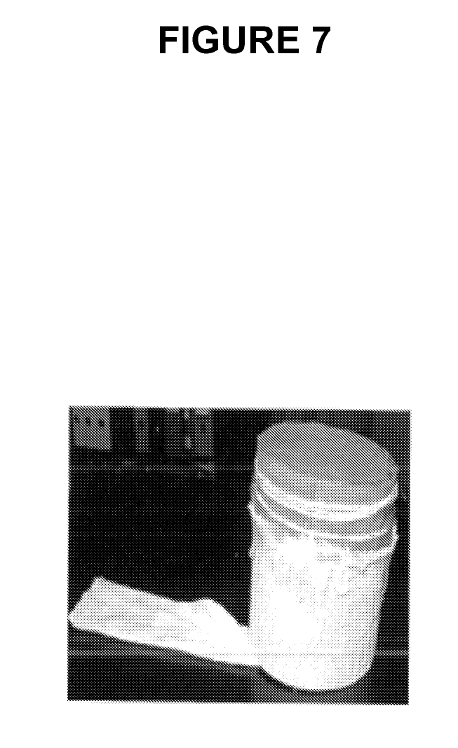

The mosquitoes were tested in an apparatus called a testing chamber. This chamber was constructed of PVC tubes having a height of 11 cm and a diameter of 10 cm. The lumen of the tube was closed by a piece of plastic screen having a mesh of 7 openings per cm. Its face abutted the skin of the sheep such that the mosquitoes can bite. The other lumen of the tube was fitted with a tubular sleeve “Jersey” and permits the introduction of the mosquitoes into the chamber. The tube is closed with a rubber band such that the mosquitoes could not escape. A picture of the testing chamber is shown in FIG. 7. A dozen of identical chambers were fabricated and numbered 1 to 12. A piece of cotton wool (1.5 g) saturated with 20 ml of water was placed on the mesh covering the mosquitoes and was covered by a glass Petri dish. The mosquitoes were left in their chamber until the start of the test. The mosquitoes were aspirated with an entomologic aspirator and were counted using a mechanical counter. 50 mosquitoes were placed in each of the twelve testing chambers.

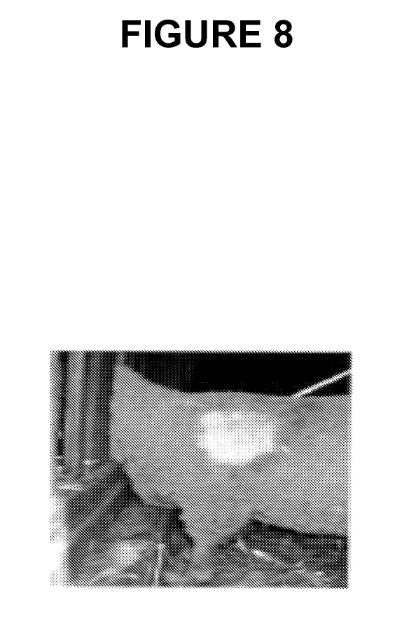

The day before the test the sheep were placed in a headlock, their wool was humidified and was removed with the help of a bistoury having a number 4 handle and a number 24 blade. After the wool was removed the sheep were shaved in two zones at a diameter of 13 cm using a piece of PVC hose having a width and diameter of 10 cm to guide the manipulation. These zones were situated to the right and left of the animal. The shaved zones were situated at the top of the forelimbs of the animal and about 15 cm from the withers to the chest shoulder interface of the sheep. A picture of the completion of this procedure is shown in FIG. 8. The shaved “white” zone was then washed with warm water and a detergent of typol and rinsed with the aid of an absorbent paper soaked with clear water. The skin and the wool around the zone were then dried using an absorbent paper. Once the sheep were shaved they were released from the headlock. The same procedure was repeated with the three sheep at the other sheep farm.

At the day of the test the 3 sheep were placed in a headlock. One place of the headlock is left open between each sheep. Using a template that was fabricated in plastic and was 12 cm in diameter one technician held the template in place while the other technician traced the shaved zone with a ballpoint pen. This procedure was followed for all three sheep. The mosquitoes were then brought to the test site and maintained in a dry environment without light until the experiment began.

For each sheep there were two treatments that were coded A (the control) and B (the semiochemical product) that were placed in a syringe and distributed to the test center. The semiochemical active principle was in a concentration of 313 μg/cm³. A technician, wearing a vinyl glove, took 0.4 ml of syringe A (control) and distributed it to the center of the shaved zone. The 0.8 ml that was left was distributed on the median line dividing the area's width. The technician then first spreads the treatment on the surface in the form of a spiral (see 1 below). To ensure a good distribution of the solution the technician then streaks the solutions 2 times in the manner shown in 2, 3 and 4 below:

The same procedure was repeated with solution B (semiochemical) after the technician changed the vinyl gloves.

The following Table 68 shows below the application of the treatment A and B with respect to the sheep and the test chambers of mosquitoes that were utilized:

TABLE 68

| | | Number of test | | Treatment |
|---|---|---|---|---|
| | Number | chamber of the | Area of | in order of area |
| Date of test | of test | mosquitoes | application | of application |
| March 27 | 1 | 1, 2 | right, left | A, B |
| March 27 | 2 | 3, 4 | right, left | B, A |
| March 27 | 3 | 5, 6 | right, left | A, B |
| March 27 | 4 | 7, 8 | right, left | B, A |
| March 27 | 5 | 9, 10 | right, left | A, B |
| March 27 | 6 | 11, 12 | right, left | B, A |
| March 28 | 7 | 1, 2 | right, left | B, A |
| March 28 | 8 | 3, 4 | right, left | A, B |
| March 28 | 9 | 5, 6 | right, left | B, A |
| March 28 | 10 | 7, 8 | right, left | A, B |
| March 28 | 11 | 9, 10 | right, left | B, A |
| March 28 | 12 | 11, 12 | right, left | A, B |

where A is the control and B is the semiochemical product

The mosquitoes in their testing chambers were then placed in the center of the shaved portion of the sheep by one technician while the other technician placed an elastic strap on the chest of the sheep to hold the test chamber. A stopwatch was used to determine the contact time of 30 minutes between the sheep and the mosquitoes. The 6 chambers were paired as 1-2, 3-4, 5-6, 7-8, 9-10 and 11-12. Each test chamber was placed to the right of the animal for each test.

30 minutes after the application the mosquitoes in the test chambers were withdrawn by first removing the elastic strap. The mosquitoes were then frozen in a freezer at −20° C. for at least 15 minutes.

The treatment zone of the sheep was then washed with a solution of DEG SUPER neutre®, which is a degreasing detergent that is ultraconcentrated without perfume or colorants, which was distributed on absorbent paper. After washing the zone was rinsed with warm water. The three sheep were then liberated.

The test was then performed in the same manner on the second set of three sheep.

The frozen mosquitoes were then taken from the freezer and placed on adhesive tape with a length of 12 cm and a width of 5 cm. The mosquitoes that were “glued” to the tape formed 10 columns with 5 mosquitoes each. A piece of absorbent paper was placed on the tacky surface of the adhesive tape enclosing the mosquitoes between the adhesive tape and absorbent paper.

The adhesive tape and the absorbent paper containing the dead mosquitoes affixed thereto was then placed under a binocular microscope where the presence of blood was observed by backlight on the abdomen of the mosquitoes. The mosquitoes were classified in two categories; those where blood was observed in the abdomen and those who had no blood in their abdomen. The presence of blood was confirmed by crushing the abdomen of the mosquitoes by sliding the end of a clamp to the apex of the abdomen.

For each test the amount of protection was calculated based on the formula:

T=(G/G+NG)×100
where T=the average engorgement of the control zone on the sheep
G=number of mosquitoes bites on the control zone on the sheep
NG=number of mosquitoes that did not bite the control zone on the sheep and

V=(G₁/G₁+NG₁)×100
where V=the average engorgement of the 6 treated zones on the sheep
G₁=the number of mosquito bites on the 6 treated zones on the sheep
NG₁=number of mosquitoes that did not bite the 6zones on the treated sheep

The formula of the percentage of diminution of bites with respect to the control was calculated as follows:

% efficacy=(1−V/T)×100

where V=the average engorgement of the treated zone on the sheep

T=the average engorgement of the control zone on the sheep

If the mosquito bites for the semiochemical treatment were inferior to 20% the test was discarded.

The descriptive statistics are set forth in Table 69 below for the control A.

TABLE 69

| | Variable | | | | | |
|---|---|---|---|---|---|---|
| | Treatment | | | | | Treatment |
| | A-control | Treatment | Treatment | Treatment | Treatment | A-control |
| | Number in | A-control | A-control | A-control | A-control | Standard |
| | test | Average | Median | Minimum | Maximum | deviation |
| Number of bites | 12 | 72.30588 | 70.00000 | 51.92308 | 95.91837 | 14.41281 |

The descriptive statistics are set forth in Table 70 below for the treatment B with the semiochemical product.

TABLE 70

| | Variable | | | | | |
|---|---|---|---|---|---|---|
| | Treatment | Treatment | Treatment | Treatment | Treatment | Treatment B |
| | B-semiochemical | B- | B- | B- | B- | semiochemical |
| | Number in | semiochemical | semiochemical | semiochemical | semiochemical | Standard |
| | Test | Average | Median | Minimum | Maximum | deviation |
| Number | 12 | 4.277700 | 1.00000 | 0.000 | 13.95349 | 5.794567 |
| of | | | | | | |
| bites | | | | | | |

Descriptive statistics comparing the location on the side of the sheep of each test was then undertaken. The results are set forth in Tables 71 and 72 below.

TABLE 71

| | Variable | | | | | |
|---|---|---|---|---|---|---|
| | right | | | right | | right |
| | Number | right | right | Mini- | right | Standard |
| | in Test | Average | Median | mum | Maximum | deviation |
| Number | 12 | 39.59411 | 34.72877 | 0.00 | 95.91837 | 40.64922 |
| of bites | | | | | | |

TABLE 72

| | Variable | | | | | |
|---|---|---|---|---|---|---|
| | left | | | left | | left |
| | Number | left | left | Mini- | left | Standard |
| | in Test | Average | Median | mum | Maximum | deviation |
| Number | 12 | 36.98947 | 32.93828 | 0.00 | 84.78261 | 33.30944 |
| of bites | | | | | | |

The results were transformed using the Box-Cox transformation that ameliorates the residues and heterogeneous variances.

Table 73 illustrates the results of a simplified model without interaction using Univariate tests of significance for the sheep.

TABLE 73

| | Sum of | Degree of | Mean | Degree of | |
|---|---|---|---|---|---|
| effect | squares | liberty | square | freedom F | P value |
| Ordinate of | 2310.054 | 1 | 2310.054 | 564.2090 | 0.00000 |
| origin | | | | | |
| Number of | 81.128 | 11 | 7.375 | 1.8013 | 0.171701 |
| Sheep | | | | | |
| Treatment | 1423.431 | 1 | 1423.431 | 347.6595 | 0.00000 |
| error | 45.038 | 11 | 4.094 | | |

Table 73 shows that the tests on the two groups of sheep are not significant. However the treatment with the semiochemical is highly significant.

Table 74 illustrates the results of a simplified model without interaction using Univariate tests of significance for the mosquitoes used in this example.

TABLE 74

| | Sum of | Degree of | Mean | Degree of | |
|---|---|---|---|---|---|
| effect | squares | liberty | square | freedom F | P value |
| Ordinate of | 2310.054 | 1 | 2310.054 | 503.8088 | 0.00000 |
| origin | | | | | |
| Number of | 48.217 | 5 | 9.643 | 2.1032 | 0.114906 |
| mosquitoes | | | | | |
| Treatment | 1423.431 | 1 | 1423.431 | 310.4415 | 0.00000 |
| error | 77.948 | 17 | 4.585 | | |

Table 74 shows that there was not any significant difference between the mosquitoes used in the test. However the treatment with the semiochemical was highly significant.

Table 75 illustrates the results of a simplified model without interaction using

Univariate tests of significance for the location of the mosquitoes on the sheep; i.e., right or left in the testing chamber.

TABLE 75

| | Sum of | Degree of | Mean | Degree of | |
|---|---|---|---|---|---|
| effect | squares | liberty | square | freedom F | P value |
| Ordinate of | 2310.054 | 1 | 2310.054 | 387.9405 | 0.00000 |
| origin | | | | | |
| Location | 1.117 | 1 | 1.117 | 0.1876 | 0.669310 |
| Treatment | 1423.431 | 1 | 1423.431 | 239.0448 | 0.00000 |
| error | 4125.048 | 21 | 5.955 | | |

Table 75 shows that there was not any significant difference between the mosquitoes in the test chambers applied to the sheep on the right or left side. However the treatment with the semiochemical was highly significant.

The effect of inhibition of attraction was determined as a function of the number of mosquitoes that did not bite. The mosquitoes that did not bite were considered to be inhibited from landing on the sheep.

The following calculation was used to determine inhibition:

Attraction for inhibition (AFI)=100−nt/nc×100

where nt=the number of mosquitoes not inhibited by the treatment; and
nc=the number of mosquitoes not inhibited by the control.

Thus, AFI=100−(4.3/72.3)×100=94%

The different sheep used at different sheep farms, the localization of the mosquitoes on the right or left of the sheep and the mosquitoes used in the test showed that these variances were not significant. The treatment using the semiochemical product was highly significant and showed a 94% inhibition efficacy.

While the invention has been described in terms of various preferred to embodiments, the skilled artisan will appreciate that various modifications, substitutions, omissions and changes may be made without departing from the scope thereof. Accordingly, it is intended that the scope of the present invention be limited by the scope of the following claims, including equivalents thereof.

1-47. (canceled)

48. A semiochemical composition comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle.

49. A semiochemical composition comprising a synthetic Hematophagous Diptera bite inhibitor semiochemical, said composition comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclohexyl propionic acid and methylated cyclohexyl acetic acid or 3-cyclopentyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that retain their semiochemical activity and/or their mixtures thereof and an acceptable vehicle.

50. The semiochemical composition according to claim 48, wherein the semiochemical composition comprising a synthetic Hematophagous Diptera bite inhibitor semiochemical composition comprises at least one compound selected the group of from between about 0.01% (w %/w %) to about 10% (w %/w %) 3-cyclopentyl 2-methyl propionic acid, from between about 0.01% (w %/w %) to about 10% (w %/w %) 3-cyclohexyl 2-methyl propionic acid and from between about 0.01% (w %/w %) to about 10% (w %/w %) methylated cyclohexyl acetic acid in said semiochemical composition.

51. The semiochemical composition according to claim 48, wherein said salts, said derivatives, said isomers and/or said structural analogs that retain their semiochemical activity and/or said mixtures of 3-cyclopentyl 2-methyl propionic acid, 3-cyclohexyl 2-methyl propionic acid or methylated cyclohexyl acetic acid are present in said semiochemical composition in a range from between about 0.01% (w %/w %) to about 10% (w %/w %).

52. The semiochemical composition according to claim 48, wherein said synthetic Hematophagous Diptera bite inhibitor semiochemical composition comprises at least one compound selected from the group of between about 0.05% (w %/w %) to about 15% (w %/w %) 3-cyclopentyl 2-methyl propionic acid, from between about 0.05% (w %/w %) to about 15% (w %/w %) 3-cyclohexyl 2-methyl propionic acid and from between about 0.05% (w %/w %) to about 15% (w %/w %) methylated cyclohexyl acetic acid.

53. The semiochemical composition according to claim 48, wherein said salts, said derivatives, said isomers and/or said structural analogs that retain their semiochemical activity and/or said mixtures of 3-cyclopentyl 2-methyl propionic acid, 3-cyclohexyl 2-methyl propionic acid or methylated cyclohexyl acetic acid are present in said semiochemical composition in a range from between about 0.05% (w %/w %) to about 15% (w %/w %).

54. The semiochemical composition according to claim 49, comprising at least one of the mixtures of cyclic compounds and methylated cyclic compounds, wherein the 3-cyclopentyl propionic acid and 3-cyclohexyl 2-methyl propionic acid is present in the semiochemical composition in a range of between about 0.01% (w %/w %) to about 10% (w %/w %); 3-cyclopentyl 2-methyl propionic acid and 3-cyclohexyl propionic acid is present in the semiochemical composition in a range of between about 0.01% (w %/w %) to about 10% (w %/w %); the 3-cyclopentyl propionic acid and methylated cyclohexyl acetic acid is present in the semiochemical composition in a range of between about 0.01% (w %/w %) to about 10% (w %/w %); the 3-cyclohexyl propionic acid and methylated cyclohexyl acetic acid is present in the semiochemical composition in a range of between about 0.01% (w %/w %) to about 10% (w %/w %); the 3-cyclohexyl propionic acid and 3-cyclohexyl 2-methyl propionic acid is present in the semiochemical compositions in a range between about 0.01% to about 10% (w %/w %); the 3-cyclopentyl propionic acid and 3-cyclopentyl 2-methyl propionic acid is present in the semiochemical composition a range of between about 0.01% (w %/w %) to about 10% (w %/w %); the cyclohexyl acetic acid and methylated cyclohexyl acetic acid is present in the semiochemical composition in a range of between about 0.01% (w %/w %) to about 10% (w %/w %); the 3-cyclopentyl 2-methyl propionic acid and cyclohexyl acetic acid is present in the semiochemical composition in a range of between about 0.01% (w %/w %) to about 10% (w %/w %); and the 3-cyclohexyl 2-methyl propionic acid and cyclohexyl acetic acid is present in a range of between about 0.01% (w %/w %) to about 10% (w %/w %).

55. The semiochemical composition according to claim 49, wherein said salts, said derivatives, said isomers and/or said structural analogs that retain their semiochemical activity and/or said mixtures of said at least one of the mixtures of said cyclic compounds and methylated compounds are present in said semiochemical composition in a range from between about 0.01% (w %/w %) to about 10% (w %/w %).

56. The semiochemical composition according to claim 49, comprising a synthetic Hematophagous Diptera bite inhibitor semiochemical comprising at least one of the following mixtures of cyclic compounds and methylated cyclic compounds, wherein the 3-cyclopentyl propionic acid and 3-cyclohexyl 2-methyl propionic acid is present in the semiochemical composition in a range of between about 0.05% (w %/w %) to about 15% (w %/w %); 3-cyclopentyl 2-methyl propionic acid and 3-cyclohexyl propionic acid is present in the semiochemical composition in a range of between about 0.05% (w %/w %) to about 15% (w %/w %); the 3-cyclopentyl propionic acid and methylated cyclohexyl acetic acid is present in the semiochemical composition in a range of between about 0.05% (w %/w %) to about 15% (w %/w %); the 3-cyclohexyl propionic acid and methylated cyclohexyl acetic acid is present in the semiochemical composition in a range of between about 0.05% (w %/w %) to about 15% (w %/w %); the 3-cyclohexyl propionic acid and 3-cyclohexyl 2-methyl propionic acid is present in the semiochemical compositions in a range between about 0.05% to about 15% (w %/w %); the 3-cyclopentyl propionic acid and 3-cyclopentyl 2-methyl propionic acid is present in the semiochemical composition a range of between about 0.05% (w %/w %) to about 15% (w %/w %); the cyclohexyl acetic acid and methylated cyclohexyl acetic acid is present in the semiochemical composition in a range of between about 0.05% (w %/w %) to about 15% (w %/w %); the 3-cyclopentyl 2-methyl propionic acid and cyclohexyl acetic acid is present in the semiochemical composition in a range of between about 0.05% (w %/w %) to about 15% (w %/w %); and the 3-cyclohexyl 2-methyl propionic acid and cyclohexyl acetic acid is present in a range of between about 0,05% (w %/w %) to about 15% (w %/w %).

57. The semiochemical composition according to claim 49, wherein said salts, said derivatives, said isomers and/or said structural analogs that retain their semiochemical activity and/or said mixtures of said at least one of the mixtures of said cyclic compounds and methylated compounds are present in said semiochemical composition in a range from between about 0.05% (w %/w %) to about 15% (w %/w %).

58. The semiochemical composition according to claim 48, wherein said derivatives are esters, alcohols ketones, amides, ether, aldehydes and sterols of said compounds.

59. The semiochemical composition according to claim 49, wherein said derivatives are esters, alcohols ketones, amides, ether, aldehydes and sterols of said compounds.

60. A semiochemical solution comprising the semiochemical compositions according to claim 48.

61. A semiochemical solution comprising the semiochemical compositions according to claim 49.

62. A method to prevent Hematophagous Diptera insects from landing and biting animals comprising administering to animals in need of such treatment or placing in the environment of animals a synthetic insect bite inhibiting semiochemical composition or a synthetic semiochemical solution comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle.

63. A method to prevent Hematophagous Diptera insects from landing and biting animals comprising administering to animals in need of such treatment or placing in the environment of animals a synthetic insect bite inhibiting semiochemical composition or a synthetic semiochemical solution, said semiochemical composition or semiochemical solution, said composition or solution comprising at least one of the following mixtures of cyclic compounds and methylated cyclic compounds: 3-cyclopentyl propionic acid and 3-cyclohexyl 2-methyl propionic acid or 3-cyclopentyl 2-methyl propionic acid and 3-cyclohexyl propionic acid or 3-cyclopentyl propionic acid and methylated cyclohexyl acetic acid or 3-cyclohexyl propionic acid and methylated cyclohexyl acetic acid or 3-cyclopentyl propionic acid and 3-cyclopentyl 2-methyl propionic acid or 3-cyclohexyl propionic acid and 3-cyclohexyl 2-methyl propionic acid or cyclohexyl acetic acid and methylated cyclohexyl acetic acid or 3-cyclopentyl 2-methyl propionic acid and cyclohexyl acetic acid or 3-cyclohexyl 2-methyl propionic acid and cyclohexyl acetic acid, their salts thereof, their derivatives thereof, their isomers thereof and/or their structural analogs thereof that retain their semiochemical activity and/or their mixtures thereof and an acceptable vehicle.

64. A semiochemical composition or semiochemical solution comprising a synthetic Hematophagous Diptera bite inhibitor semiochemical composition comprising at least one compound selected from the group of 3-cyclopentyl 2-methyl propionic acid, 3-cyclohexyl 2-methyl propionic acid and methylated cyclohexyl acetic acid, their salts thereof, their derivatives thereof, their isomers thereof and/or their structural analogs thereof that retain their semiochemical activity and/or their mixtures thereof and an acceptable vehicle for the fabrication of an insect repellant to prevent Hematophagous Diptera insects from landing and biting animals.
